(19) United States
(12) Patent Application Publication
(10) Pub. No.: US 2026/0279341 A1
(43) Pub. Date: Sep. 17, 2026

(54) SYSTEM

(71) Applicant: SoftBank Group Corp., Tokyo (JP)

(72) Inventor: Hirotomo OSANAI, Tokyo (JP)

(73) Assignee: SoftBank Group Corp., Tokyo (JP)

(21) Appl. No.: 19/551,627

(22) Filed: Feb. 27, 2026

Related U.S. Application Data
(60) Provisional application No. 63/771,309, filed on Mar. 13, 2025.

(51) Int. Cl. G10L 15/06; G06F 9/451; G06N 3/0475; G10L 13/027; G10L 15/01; G10L 15/16; G10L 15/18; G10L 21/0264; G10L 21/034; G10L 25/21; G10L 25/24; G10L 25/63; G10L 25/90

(52) U.S. Cl. CPC G10L 15/063; G06F 9/454; G06N 3/0475; G10L 13/027; G10L 15/01; G10L 15/16; G10L 15/1807; G10L 21/0264; G10L 21/034; G10L 25/21; G10L 25/24; G10L 25/63; G10L 25/90; G10L 2015/0635

(57) ABSTRACT

A system includes a processor that is configured to collect audio data from residents who speak a dialect in a specific region, perform preprocessing on the collected audio data by removing noise from the audio data and converting the audio data into text, train a generative artificial intelligence model to learn dialect-specific pronunciation and intonation based on the preprocessed audio data and corresponding text data, evaluate an accuracy of speech recognition by using a trained model, and expand support for speech recognition from a particular dialect for which speech recognition has been put into practical use to additional dialects.

### CROSS-REFERENCE TO RELATED APPLICATION

This application claims the benefit of U.S. Provisional Application No. 63/771,309, filed on Mar. 13, 2025, pursuant to 35 U.S.C. § 119 (e), the entire contents of which are incorporated herein by reference.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional speech recognition systems are generally designed and trained on standard language data and therefore exhibit significantly degraded recognition accuracy when processing dialectal speech used by residents in specific regions. In particular, elderly users and other speakers who predominantly use regional dialects often encounter difficulties in operating information technology devices by voice, which exacerbates the digital divide. Existing approaches do not sufficiently address the need to systematically collect dialectal audio data, to extract and formalize dialect-specific words and expressions in relation to standard language, and to train and evaluate speech recognition and generative artificial intelligence models that can robustly handle diverse dialects. Furthermore, conventional systems do not provide an integrated mechanism to expand support from a particular dialect that has reached practical performance to additional dialects in a scalable manner. Accordingly, there is a need for a system and method that can improve speech recognition accuracy for dialectal speech, enable natural voice-based operation of devices by dialect speakers, including elderly users, and provide an efficient framework for extending support to multiple regional dialects.

### SUMMARY

In order to solve the above-described problems, the present invention provides a system comprising a processor configured to execute a series of functions corresponding to audio data collection, data preprocessing, model training, testing and evaluation, and dialect support expansion. The processor is configured to collect audio data from residents who speak a dialect in a specific region, including audio data of daily conversations and audio data based on specific scenarios, by using devices such as smartphones or dedicated recording devices and to store the audio data in a digital format. The processor is further configured to perform preprocessing on the collected audio data by cleaning the audio data, removing noise, detecting speech segments, and converting the preprocessed audio data into text using a speech recognition model. During this conversion, the processor is configured to extract dialect-specific words and expressions from the recognized text and to clarify correspondence relationships between the dialect-specific words and expressions and standard language, thereby building and updating a dialect-to-standard mapping database.

Moreover, the processor is configured to select and train a generative artificial intelligence model and a speech recognition model using deep learning, by using pairs of preprocessed audio data and corresponding text data so that the models learn dialect-specific pronunciation and intonation and understand relationships between dialectal expressions and standard language expressions. The processor is further configured to evaluate an accuracy of speech recognition by applying the trained model to test audio data, compare recognition results with reference text, measure recognition accuracy, analyze causes of misrecognition, adjust model parameters as needed, and perform retraining to improve performance. In addition, the processor is configured to expand support for speech recognition from a particular dialect that has achieved a practical level of recognition accuracy to additional dialects by repeating the steps of collecting dialectal audio data, performing preprocessing, training and evaluating models, and updating dialect-to-standard mappings for each new dialect. By executing these functions in an integrated manner, the system according to the present invention improves speech recognition performance for dialectal speech, enables natural voice-based operation of devices by dialect speakers, and provides a scalable framework for systematically extending support to multiple regional dialects.

The term “system” refers to an arrangement of hardware and/or software components, including at least one processor and associated memory and interfaces, that collectively perform the claimed functions for collecting, processing, recognizing, generating, evaluating, and expanding support for dialectal speech.

The term “processor” refers to one or more hardware processing units, such as a central processing unit (CPU), graphics processing unit (GPU), digital signal processor (DSP), microcontroller, or a combination thereof, that executes instructions to carry out the functions described in the claims.

The term “audio data” refers to digital representations of sound, including voice signals captured from users, stored in a machine-readable format such as pulse-code modulation (PCM) or compressed audio formats.

The term “dialect” refers to a regional or local linguistic variety of a language used by residents in a specific geographic area, which includes characteristic pronunciation, vocabulary, grammar, and intonation that differ from a standard form of the language. The term “residents who speak a dialect in a specific region” refers to individuals living in a particular geographic area who primarily or frequently use a regional dialect in their daily speech.

The term “digital format” refers to a representation of data as discrete numerical values that can be stored, processed, and transmitted by electronic devices, including digitized audio signals.

The term “smartphone” refers to a portable electronic device that combines mobile telephony with computing capabilities, having at least a processor, a microphone, a display, and a network interface, and that is capable of recording and transmitting audio data.

The term “dedicated recording device” refers to an electronic device that is specifically designed or configured to capture and store audio data, and that includes at least a microphone, a processor or controller, and a storage unit.

The term “daily conversations” refers to spoken utterances that occur in ordinary, non-scripted interactions in everyday life, such as conversations with family members, friends, or service personnel.

The term “specific scenarios” refers to predefined or guided situational contexts, such as shopping, hospital visits, travel, or other tasks, in which users are prompted or instructed to speak particular phrases or sentences.

The term “preprocessing” refers to operations performed on raw audio data before higher-level analysis or model training, including at least one of noise removal, cleaning, volume normalization, segmentation, and feature extraction.

The term “noise removal” refers to processing applied to audio data to reduce or eliminate undesired sounds, such as background noise, hum, or echo, while preserving speech content as much as possible.

The term “converting the audio data into text” refers to performing automatic speech recognition to transform spoken utterances contained in audio data into a sequence of characters, words, or tokens in a written language.

The term “speech recognition model” refers to a statistical or machine learning model, implemented in software or hardware, that receives audio or acoustic features as input and outputs a transcription of spoken language in text form.

The term “generative artificial intelligence model” refers to a machine learning model that is trained to generate text or other output data in response to input prompts, and that can produce dialectal expressions based on learned patterns of pronunciation, vocabulary, and intonation.

The term “dialect-specific pronunciation and intonation” refers to patterns of sound production and prosody, including pitch, rhythm, stress, and segmental realizations, that are characteristic of a particular dialect and differ from those of the standard language.

The term “dialect-specific words and expressions” refers to lexical items, phrases, idioms, and constructions that are used in a particular dialect and are absent from or differ in form or meaning from corresponding items in the standard language.

The term “standard language” refers to a codified or generally accepted form of a language used in formal communication, education, media, and official documents, and against which dialectal variations are defined.

The term “correspondence relationships between dialect-specific words and expressions and standard language” refers to mappings that associate dialectal lexical items or phrases with their equivalents or approximations in the standard language.

The term “dialect-to-standard mapping database” refers to a data structure stored in memory that contains entries linking dialect-specific words and expressions to corresponding standard language words and expressions, optionally including metadata such as frequency of use and context.

The term “pairs of audio data and corresponding text data” refers to aligned training examples in which each audio recording of speech is associated with a correct transcription or representation in text, in either dialectal or standard language form.

The term “training” refers to a process of adjusting parameters of a model, such as weights in a neural network, using data and an optimization procedure so that the model learns to perform tasks such as speech recognition or dialect text generation.

The term “deep learning” refers to a class of machine learning techniques that use neural networks with multiple layers to automatically learn hierarchical representations from data, particularly suitable for complex tasks such as speech and language processing.

The term “evaluate an accuracy of speech recognition” refers to the act of quantitatively assessing the performance of a speech recognition model by comparing its outputs with reference or ground-truth transcriptions and computing metrics such as word error rate or recognition rate.

The term “misrecognition” refers to an error in which a speech recognition model outputs an incorrect or incomplete transcription of spoken input compared to a reference transcription.

The term “adjust model parameters” refers to modifying the values of parameters of a model, such as weights, biases, or hyperparameters, in order to change the model's behavior and improve performance based on evaluation results.

The term “retraining” refers to a process of executing additional training of a model, either from an initial state or from a previously trained state, using new or augmented training data, in order to enhance or adapt the model's performance.

The term “expand support for speech recognition from a particular dialect to additional dialects” refers to enabling the system to recognize and process speech in new dialects beyond an originally supported dialect by executing additional data collection, preprocessing, training, and evaluation procedures specific to those new dialects.

The term “practical use” refers to a state in which speech recognition performance for a particular dialect has reached a level sufficient for deployment in real-world applications, such as device operation, services, or user interaction, with acceptable accuracy and reliability.

The term “test audio data” refers to audio recordings that are reserved for evaluation of model performance and are not used during the training phase, and that are associated with reference transcriptions for comparison.

The term “scenario” refers to a defined use case or situational context, such as shopping, hospital visits, or schedule management, for which specific prompts and expected utterances are designed to collect or process speech data.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

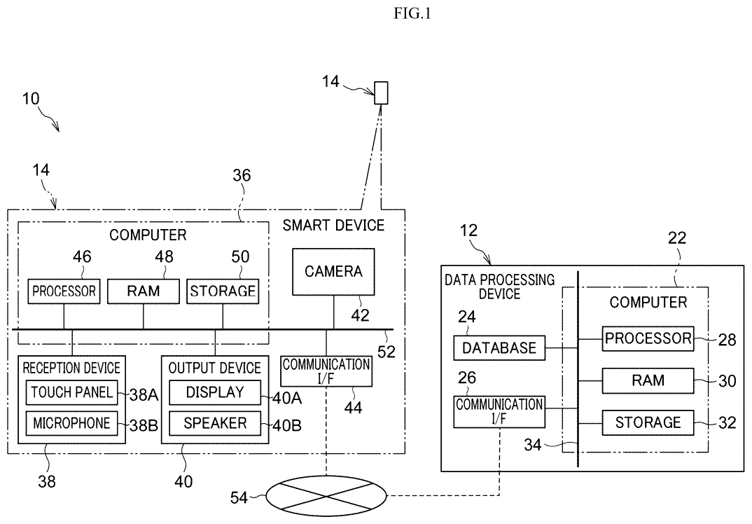

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

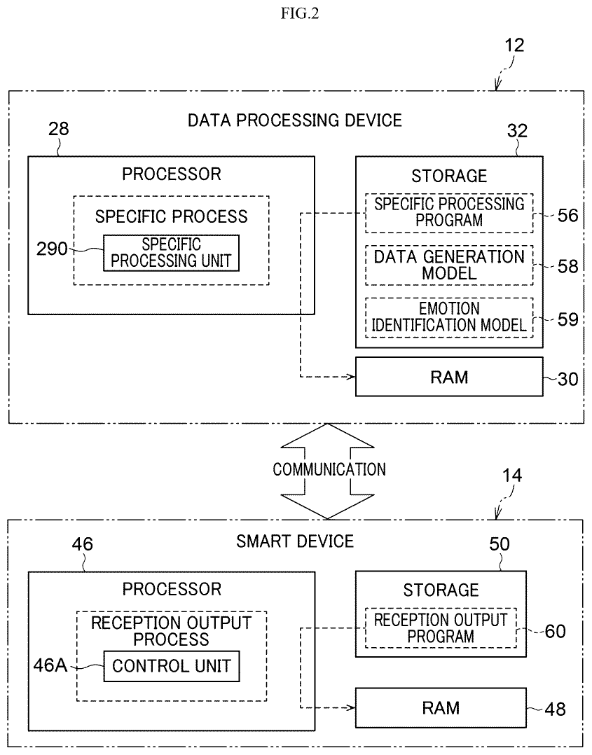

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional speech recognition systems and language processing systems are typically designed and optimized for a standard language and assume relatively clean input audio and abundant, well-labeled training data. When such systems are applied to dialectal speech uttered by actual users, particularly elderly users in everyday environments, the systems suffer from several technical deficiencies. First, the recognition accuracy for dialectal expressions significantly degrades because conventional models are trained on corpora that do not adequately cover region-specific vocabulary, pronunciation, and prosody. Second, existing architectures often treat the speech recognition component and any dialect normalization component as separate, loosely coupled modules that do not share a unified training process, thereby limiting the ability of the system to adaptively learn and correct dialect-specific errors. Third, data collection workflows in known systems do not structurally link the dialog context, such as scenario-based prompt sentences, with the collected dialectal audio and the resulting transcriptions, so that valuable contextual signals are not effectively utilized in model training. Fourth, when support for additional dialects is required, conventional systems must rely on manual rule creation or large new annotated corpora, resulting in high cost and long development time, and making it impractical to scale coverage to many dialects with sparse data.

Accordingly, there is a need for a technical framework that improves the underlying computer technology of speech and language processing by: (i) tightly integrating dialect-aware preprocessing, recognition, normalization, and model training in a server-side processing pipeline; (ii) structurally coupling user-side prompt sentences, dialect speech, and standard language counterparts as machine-readable training data; (iii) employing a generative AI model that is trained end-to-end on such structured data to perform both dialect-standard conversion and dialect-aware recognition post-processing; and (iv) enabling efficient expansion to multiple dialects, including dialects for which only limited speech data is available, through systematic data augmentation driven by the generative AI model itself. There is also a need to improve the way processors store, index, and use acoustic and prosodic features in conjunction with dictionary information so that the computing system can more accurately model dialect-specific patterns and thereby improve recognition performance, latency characteristics, and robustness of the overall speech interface.

The specific processing by the specific processing unit 290 of the data processing device 12 in Example 1 is realized by the following means.

The present invention provides a server comprising a processor configured to receive, via a communication network, dialectal speech information and associated prompt sentences from user-operated information processing terminals; to store the speech information in a storage medium and register attribute information including dialect labels, scenario labels, and prompt sentence identifiers in a management storage; to execute signal processing on the received speech information, including at least noise reduction, removal of silent segments, and normalization of sound level, to generate preprocessed speech data; to input the preprocessed speech data to a speech recognition process and obtain character string information including dialect expressions; to perform language processing on the character string information to extract dialect vocabulary and to generate and update dictionary information representing correspondence between dialect vocabulary and standard language vocabulary; to calculate acoustic features and prosodic features from at least the speech information and associate and store those features with the dictionary information in a feature storage; to generate training data that combines the dictionary information, the acoustic features, the prosodic features, and the prompt sentences, and to use the training data to train a generative AI model that performs conversion between dialect expressions and standard language expressions and that executes dialect-aware post-processing on results of the speech recognition process; to input evaluation data to the generative AI model, compare model outputs with reference data, compute evaluation indices, analyze causes of misrecognition or mis-conversion, and automatically adjust learning conditions or configuration parameters of the generative AI model and perform relearning; to construct, for a plurality of regional dialects, either a single generative AI model shared among the dialects or separate generative AI models for respective dialects by generating dialect-specific training data, and to select and switch an appropriate generative AI model based on a dialect type; and to, during runtime interaction, input dialect speech information from the terminals into the speech recognition process and the generative AI model, generate instruction information normalized into standard language, and transmit the instruction information back to the terminals for controlling information processing apparatuses. This enables an improvement in computer technology by providing a unified, dialect-aware speech processing architecture in which the processor efficiently integrates context-aware data collection, feature computation, dictionary management, and generative AI model training and inference, thereby increasing recognition accuracy for dialectal speech, reducing dependency on large manually annotated corpora, and facilitating scalable extension to multiple dialects with constrained data.

The term “system” refers to an arrangement of one or more hardware devices and software components that cooperate to execute processing steps, including at least an information processing server and one or more user-operated terminals interconnected via a communication network.

The term “server” refers to an information processing apparatus including at least one processor, a memory, and a communication interface, the server being configured to perform centralized processing such as storage, signal processing, speech recognition, language processing, model training, and inference.

The term “processor” refers to one or more processing units, such as a central processing unit, a graphics processing unit, or a dedicated accelerator, capable of executing instructions to perform arithmetic operations, logical operations, data transfer, and control operations as described in the claims.

The term “information processing terminal” refers to a user-operated computing device, such as a portable communication device, a tablet device, a personal computer, or a dedicated recording device, that is capable of capturing speech, displaying information, and communicating with the server over a communication network.

The term “user” refers to a human operator who interacts with the information processing terminal by viewing displayed information and uttering speech, including dialectal speech, that is captured and transmitted to the server.

The term “communication network” refers to any wired or wireless data communication infrastructure, including at least local area networks, wide area networks, and the Internet, that enables data exchange between the server and the information processing terminal.

The term “speech information” refers to data representing sound produced by a human speaker, including at least an audio waveform or its digital representation, which may contain one or more utterances in a dialect or a standard language.

The term “dialect” refers to a variety of a natural language used in a particular region or community, characterized by specific vocabulary, pronunciation, prosodic patterns, and grammatical constructions that differ from those of a corresponding standard language.

The term “standard language” refers to a normative variety of a natural language used as a reference for general communication, education, and media, and used in the system as a canonical form for normalization and conversion of dialect expressions.

The term “prompt sentence” refers to a text string presented by the information processing terminal to the user as guidance or an instruction, the prompt sentence defining a scenario or content for the user's utterance and being transmitted to the server in association with the speech information.

The term “scenario” refers to a usage context or situation, such as a daily activity or a specific task, that is associated with one or more prompt sentences and that frames the semantic content of the user's dialect utterances.

The term “attribute information” refers to metadata associated with speech information, including at least a dialect label, a scenario label, an identification of a prompt sentence, a time stamp, and optionally a user identifier or a device identifier.

The term “management storage” refers to a logical or physical storage facility, such as a database or a metadata repository, in which the processor registers and updates attribute information, dictionary information, and model management information.

The term “storage medium” refers to any non-transitory computer-readable medium, such as a semiconductor memory, a magnetic storage device, or an optical storage device, that stores speech information, model parameters, features, or other data.

The term “signal processing” refers to computational operations applied to digital speech data, including at least filtering, noise reduction, segmentation, and normalization, for the purpose of improving data quality prior to further analysis.

The term “preprocessed speech data” refers to speech information that has been processed by the signal processing operations, including at least noise reduction, silent segment removal, and sound level normalization, and that is used as input to a speech recognition process.

The term “noise reduction” refers to processing operations that attenuate or remove undesired components such as background sounds, interference, or artifacts from speech information, while preserving speech components that are relevant to recognition.

The term “removal of silent segments” refers to processing that detects and removes or shortens portions of the speech signal with low or no energy, such as pauses or leading and trailing silences, to focus subsequent processing on active speech portions.

The term “normalization of sound level” refers to processing that adjusts amplitude or loudness of speech information to a predetermined range or reference level to reduce variability across recordings and improve stability of subsequent processing.

The term “speech recognition process” refers to a computational procedure that receives preprocessed speech data and outputs character string information representing the recognized linguistic content, using acoustic models, language models, or other statistical or neural models.

The term “character string information” refers to digital text data, such as a sequence of characters or tokens, produced by the speech recognition process, and including at least words, phrases, or sentences that may contain dialect expressions.

The term “dialect expressions” refers to one or more lexical items, phrases, or constructions within the character string information that correspond to dialect vocabulary or dialect-specific usage rather than standard language forms.

The term “language processing” refers to natural language processing operations applied to character string information, including at least tokenization, morphological analysis, vocabulary extraction, and mapping between dialect and standard language expressions.

The term “dialect vocabulary” refers to lexical units, such as words or multi-word expressions, that are identified as belonging to a dialect and that have one or more corresponding expressions in the standard language.

The term “standard language vocabulary” refers to lexical units of the standard language that are used as canonical counterparts to dialect vocabulary in mapping and conversion processes.

The term “dictionary information” refers to data structures that store associations between dialect vocabulary and standard language vocabulary, optionally including additional attributes such as frequency, region, and confidence scores, and used by the processor for conversion and normalization.

The term “dictionary information update” refers to a process in which new or modified mappings between dialect vocabulary and standard language vocabulary are added to, removed from, or revised in the dictionary information based on newly processed data or manual curation.

The term “acoustic features” refers to numerical descriptors calculated from speech information, including at least spectral features, cepstral features, and energy-related features that represent acoustic properties of the speech signal.

The term “prosodic features” refers to numerical descriptors related to temporal and suprasegmental properties of speech, including at least fundamental frequency, duration, and intensity patterns that characterize rhythm, intonation, and stress.

The term “feature storage” refers to a storage area or database in which the acoustic features and prosodic features are stored, indexed, and associated with corresponding speech information and dictionary information.

The term “training data” refers to structured data used to train the generative AI model, the data including at least dictionary information, acoustic features, prosodic features, prompt sentences, and corresponding character string information for dialect and standard language.

The term “generative AI model” refers to a machine learning model, such as a neural network based on a sequence-to-sequence or transformer architecture, that is trained to generate output text given input text and optionally additional features, and that is capable of performing conversion between dialect expressions and standard language expressions and post-processing of speech recognition results.

The term “conversion between dialect expressions and standard language expressions” refers to a computational transformation that maps a text in a dialect into a semantically equivalent text in the standard language, or vice versa, while preserving intended meaning.

The term “post-processing of speech recognition considering the dialect” refers to processing applied to initial outputs of a speech recognition process, in which dialect-specific patterns and dictionary information are used to correct recognition errors and normalize expressions.

The term “evaluation data” refers to data separate from training data, including test speech and text pairs or text-only examples, that are used to assess performance of the generative AI model and the overall system.

The term “reference data” refers to ground-truth labels, such as correct transcriptions or correct dialect-standard pairs, against which outputs of the generative AI model are compared to calculate evaluation indices.

The term “evaluation indices” refers to numerical measures, such as accuracy, error rates, or similarity scores, that quantify performance of the speech recognition process and the generative AI model.

The term “relearning” refers to a process of retraining or fine-tuning the generative AI model using updated training data or adjusted learning conditions in order to improve performance based on analysis of misrecognition or mis-conversion.

The term “learning conditions” refers to parameters that control the training procedure of the generative AI model, including at least learning rate, batch size, number of epochs, and regularization settings.

The term “configuration parameters” refers to structural and operational parameters of the generative AI model and related processes, including at least network depth, number of units, attention heads, and configuration of input and output layers.

The term “regional dialect” refers to a dialect associated with a particular geographic region or speech community, treated as a distinct category for which separate or shared models may be constructed.

The term “single generative AI model common to the plurality of regional dialects” refers to one shared model configured to process input from multiple regional dialects by using common parameters and optionally dialect identifiers.

The term “separate generative AI models for respective dialects” refers to a plurality of models, each associated with a specific dialect, that are trained and deployed independently or in a modular fashion.

The term “dialect type” refers to information indicating which regional dialect is associated with particular speech information or text, used by the processor to select an appropriate generative AI model or processing route.

The term “instruction information normalized into standard language” refers to a representation of a user's intent, expressed as text or structured data in the standard language, derived from the user's dialectal speech and used to control applications or devices.

The term “data augmentation processing” refers to a technique in which additional synthetic training data is generated, for example by using the generative AI model to produce new dialect expressions paired with standard language expressions, to increase diversity and volume of training samples.

The term “runtime interaction” refers to an operational phase in which the system processes live user input, as opposed to offline training or batch processing, to provide immediate responses or control functions.

In one embodiment, a server cooperates with one or more terminals operated by users to implement a dialect-aware speech recognition and language conversion system. The server includes at least one processor, a main memory, a non-transitory storage medium, and a network interface. The terminal includes at least one processor, a memory, an audio input device, a display device, and a communication interface. The server and the terminal are connected via a wired or wireless communication network.

A terminal implements a recording and prompting application using an operating system, such as a general-purpose mobile operating system or a desktop operating system. The terminal uses an audio input device, such as a built-in MEMS microphone driven through an audio driver and audio API (for example, an audio capture API comparable to AudioRecord or AVAudioRecorder), to capture a user's dialect speech. The terminal uses a graphical user interface framework (for example, a user interface toolkit comparable to Jetpack Compose, UIKit, or a web view-based interface) to display a prompt sentence to the user prior to or during recording.

The terminal presents to the user prompt sentences such as:
“Please say in your dialect: ‘I would like to buy three apples.’”
“Please say in your dialect: ‘How much is this?’”
“In Tsugaru dialect, how would you express ‘It's nice weather today.’?”
“In Kagoshima dialect, how would you express ‘Good morning.’?”

The user reads or follows the prompt sentence and produces dialectal utterances into the microphone. The terminal samples the acoustic signal at a fixed sampling frequency, such as 16 kHz, encodes samples as 16-bit linear PCM data, and stores the samples into an audio buffer in memory. The terminal writes the buffered data into a container format such as a waveform audio file. The terminal associates each audio file with attribute information including a dialect label, a scenario identifier, a prompt sentence identifier, a time stamp, and a terminal identifier. The terminal then transmits the audio data and the associated metadata to the server via a secure transport protocol such as HTTPS.

The server receives the audio data and metadata using a network interface managed by a server operating system and web server software. The server stores the raw audio data in a data storage, such as a file system or object storage, and inserts a record into a management storage, such as a relational database. The record contains at least a reference path to the audio file, the dialect label, the scenario identifier, the prompt sentence text, and state flags indicating a processing status. This structured storage of audio plus prompt sentence plus dialect labels provides a machine-readable training corpus that humans cannot consistently construct at scale.

The server performs signal processing on the stored audio data using a digital signal processing library such as a fast Fourier transform implementation. The server applies at least a band-pass filter to suppress frequency components outside a speech band, a noise reduction algorithm such as spectral subtraction or Wiener filtering to reduce background noise, a voice activity detection algorithm to remove leading and trailing silence, and an amplitude normalization process to adjust the average energy of the waveform. The server writes preprocessed audio into a separate file and updates the database record to reference both raw and preprocessed files.

The server executes a speech recognition process on the preprocessed audio using an acoustic and language modeling engine. In one embodiment, the server uses a neural network-based recognizer that includes a feature extraction front end (for example, mel-frequency cepstral coefficient extraction), an acoustic model (for example, a convolutional neural network or recurrent neural network or transformer encoder mapping features to phoneme or subword probabilities), and a decoder (for example, a beam search decoder with a language model). The server receives from the recognizer a character string sequence representing the recognized utterance, which can contain dialect vocabulary. The server stores the recognized character string into the database associated with the audio record.

The server performs language processing on the character string using a morphological analyzer and tokenizer, such as a segmentation routine that identifies word boundaries and part-of-speech information. The server then compares tokens in the character string against a dialect-standard dictionary stored in a dictionary table. The dictionary table stores entries where each entry associates a dialect token, one or more standard language tokens, a dialect type, and statistics such as usage frequency and confidence scores. When the server detects a token or token sequence that matches an existing dialect entry, the server reads the mapped standard language expression. When the server encounters an unknown dialect form, the server may temporarily store the unknown form as a candidate entry for further human or semi-automatic annotation.

The server generates both an original dialect transcription and a normalized standard language transcription by selectively substituting dialect tokens with corresponding standard language tokens while preserving grammatical structure when possible. The server stores both transcriptions into the database, linked to the same audio record, and increments statistics for the used dictionary entries. By maintaining separate but related dialect and standard transcriptions, the server forms consistent parallel corpora that are suitable for supervised training of conversion models.

The server calculates acoustic features and prosodic features from the preprocessed audio using a speech analysis toolkit. The server derives, for example, short-time power spectra, mel-spectrograms, cepstral coefficients, and log energy as acoustic features, and fundamental frequency contours, phone durations, and intensity trajectories as prosodic features. The server optionally uses a forced alignment engine to align each recognized token with corresponding time intervals in the audio. The server stores the feature vectors and alignment information in a feature storage area and links each feature sequence to the corresponding database record and dictionary entries. This explicit linking of linguistic and acoustic information is not achievable by manual human transcription alone and forms a specific data structure that improves later learning.

The server constructs training data for a generative AI model using these stored elements. For each utterance, the server builds an input-output pair consisting of tokens representing a prompt sentence, tokens representing a dialect transcription or a standard transcription, and, optionally, compressed representations of acoustic or prosodic patterns. In one embodiment, the generative AI model is a transformer-based sequence-to-sequence neural network including an encoder and a decoder. The encoder receives a concatenated input sequence consisting of special tokens indicating dialect type, prompt sentence tokens, and source sentence tokens; the decoder produces a target sentence token sequence, either in standard language or in the dialect.

The server initializes the generative AI model with random weights or with weights from a pre-trained language model. The server then iteratively trains the model using the constructed training data. In each training iteration, the server performs a forward pass in which the encoder transforms input tokens into contextual embeddings and the decoder generates predicted output token probabilities by applying multi-head self-attention and cross-attention, feed-forward layers, and normalization operations. The server computes a loss function, such as a cross-entropy loss between predicted token distributions and one-hot vectors representing correct target tokens. The server performs a backward pass to calculate gradients of the loss with respect to model parameters and updates the parameters using an optimization method such as Adam. The server repeats mini-batch updates over multiple epochs until loss and validation metrics converge.

The server uses evaluation data, reserved from the training corpus, to measure performance of the generative AI model. The server inputs evaluation prompt sentences and source texts into the model and obtains output sequences. The server calculates evaluation indices such as character error rate, word error rate, or BLEU score by comparing outputs to reference texts. The server then performs a systematic analysis of error patterns by clustering misrecognized or misconverted tokens by dialect type, vocabulary class, or acoustic context. Based on these analyses, the server adjusts learning conditions, such as learning rate or batch size, and in some cases modifies model architecture parameters, such as number of layers or attention heads. The server then re-trains or fine-tunes the model with updated hyperparameters. This feedback loop constitutes a specific computer-implemented optimization procedure that improves recognition and conversion accuracy compared to a static model.

The server extends support to additional dialects using data augmentation driven by the generative AI model. When the server has only sparse real speech data for a dialect, the server inputs a standard language sentence together with a prompt sentence indicating a target dialect to the generative AI model and requests generation of one or more candidate dialect expressions. For example, the server inputs:
“As a generative AI model, given the prompt sentence ‘How do you say “It's a nice day today” in Tsugaru dialect?’, output the dialect expression.”
“As a generative AI model, given the prompt sentence ‘How do you say “Good morning” in Kagoshima dialect?’, generate multiple candidate expressions and indicate a commonly used one.”

The server then treats pairs consisting of the generated dialect sentences and the corresponding standard sentences as additional training data. The server filters generated pairs based on consistency checks, such as mutual translation consistency or language detection, and then re-trains the generative AI model including these synthetic pairs. This data augmentation scheme utilizes the generative AI model in a loop to increase data diversity and coverage, which directly improves performance on low-resource dialects and cannot be replicated by trivial human transcription scaling.

During runtime operation, the terminal sends streaming audio of the user's dialect speech to the server. The server applies the same signal processing and recognition procedures, but executes them in a streaming mode optimized for low latency. The server feeds intermediate recognition results into the generative AI model, which performs on-the-fly normalization from dialect to standard language and resolves ambiguous dialect variants based on context provided by the prompt sentence and recent dialogue history. The server then produces normalized instruction information, such as “check today's weather” or “set an alarm for 7 am,” as structured tokens.

The terminal receives the normalized instruction information and uses local application logic or an operating system application programming interface to invoke corresponding functions of controlled devices or services. For example, the terminal invokes a weather information service, retrieves current weather data, and displays text such as “It's sunny today and the temperature is 20 degrees.” on the screen, or uses a text-to-speech engine to synthesize a response in standard language or in the user's dialect by applying the generative AI model in the reverse conversion direction. In another example, the terminal sets a reminder, places a call, or controls a home appliance controller via a local network.

The system thereby implements not only conversion between dialect and standard language but also concrete control of information processing devices and services. The server reduces overall processing latency by using specialized batch processing for feature extraction, by reusing cached dictionary lookups, and by using a shared generative AI model instead of multiple separate rule-based modules. The system improves recognition accuracy and reduces errors by jointly optimizing the speech recognition process and the generative AI model using common training data structures that incorporate prompt sentences, dialect labels, and acoustic features. The system also improves data management because the server maintains unified records that link raw audio, preprocessed audio, linguistic transcriptions, dictionary entries, acoustic and prosodic features, training and evaluation flags, and model version identifiers, enabling efficient retrieval and traceability.

The server employs processing rules and procedures that differ from human practice. For instance, the server assigns dialect tokens to embeddings that encode both dialect type and phonological similarity to standard vocabulary, and uses an attention mechanism in the generative AI model to weight contributions of prompt sentence tokens and dialect type tokens differently than contributions of content tokens. The server also dynamically selects, based on dialect type and scenario, whether to route input through a common generative AI model or a dialect-specific model, thereby optimizing computational load and accuracy. These non-conventional routing and embedding strategies provide a technical effect of reducing computation for frequent standard-language-dominated inputs while preserving fidelity on strongly dialectal inputs.

In alternative embodiments, the server may employ different neural network architectures, such as recurrent neural networks with attention instead of transformers, or may utilize subword tokenization schemes such as byte-pair encoding or unigram language models. The server may alter the loss function to include auxiliary losses, such as a dialect classification loss or a pronunciation consistency loss, which further guide the learning process. The terminal may be a portable communication device, a head-mounted device, a vehicle-mounted system, or a stationary kiosk, yet the interaction among prompt sentence display, dialect speech capture, and server-side processing remains consistent.

By integrating these components and algorithms, the system improves computer technology in the field of speech interfaces: it achieves higher accuracy for dialect speech than conventional systems trained only on standard language; it reduces communication load by transmitting compressed, preprocessed features or partial hypotheses in some variants instead of raw waveforms; it optimizes computation by reusing shared generative AI models across dialects with dynamic routing; and it provides robust, low-latency control of devices and services even in noisy, real-world environments.

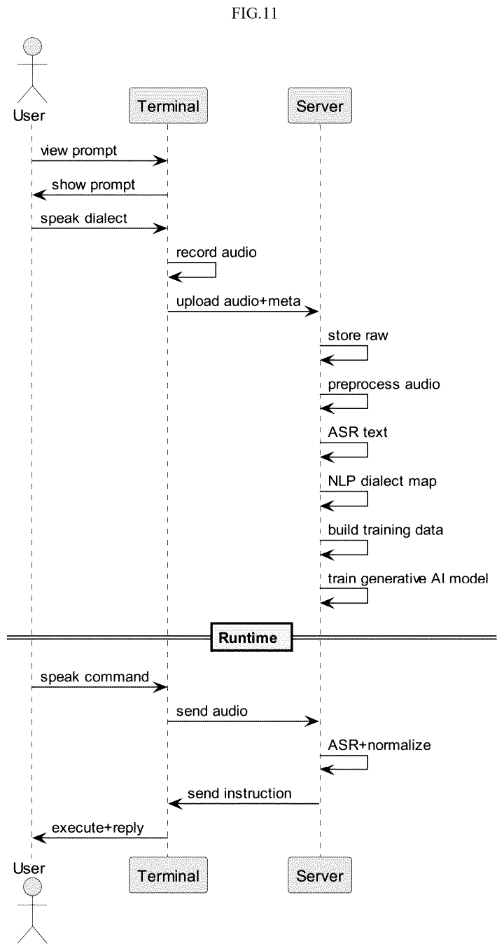

The following describes the processing flow using FIG. 11.

### Step 1:

The terminal displays a scenario and a prompt sentence to the user and prepares for recording.

The terminal takes as input a selected scenario identifier (for example, “shopping” or “daily conversation”) and retrieves from local storage or from the server a corresponding prompt sentence, such as “Please say in your dialect: ‘I would like to buy three apples.’” or “In Tsugaru dialect, how would you express ‘It's nice weather today.’?”.

The terminal performs a data lookup and UI rendering operation: the terminal reads scenario-prompt mapping data, selects the prompt sentence matching the scenario identifier, and renders the text on the display.

The terminal outputs a visible prompt sentence to the user and an internal record containing the scenario identifier and prompt sentence identifier to be attached to subsequent audio data.

### Step 2:

The user utters a dialectal sentence in response to the prompt sentence.

The user takes as input the prompt sentence displayed on the terminal and produces an audible utterance in the user's dialect that semantically corresponds to the prompt, such as a Tsugaru dialect expression for “It's nice weather today.”.

The user performs a linguistic and articulatory operation that is outside the scope of machine processing but generates an acoustic pressure waveform in the physical environment.

The user outputs a spoken dialect utterance that is captured by the terminal's microphone.

### Step 3:

The terminal records the dialect speech and generates a digital audio file with metadata.

The terminal takes as input the analog audio signal from the microphone and the internal metadata including the scenario identifier, prompt sentence identifier, dialect label, time stamp, and terminal identifier.

The terminal performs analog-to-digital conversion (sampling at a fixed frequency such as 16 kHz and quantization to 16-bit PCM), buffering, and file writing. The terminal also performs data assembly by binding the metadata to the audio file path.

The terminal outputs a digital audio file stored in local memory and an associated metadata structure that includes at least the file path, scenario identifier, prompt sentence identifier, and dialect label.

### Step 4:

The terminal uploads the audio file and metadata to the server.

The terminal takes as input the local audio file and its metadata structure.

The terminal performs a network operation by opening an HTTPS connection, packaging the audio as binary data and the metadata as a structured payload (for example, JSON fields), and sending them in a request to the server.

The terminal outputs a network message that arrives at the server and, upon successful transmission, receives an acknowledgment response from the server.

### Step 5:

The server stores the raw audio and registers a management record.

The server takes as input the uploaded audio data and metadata from the terminal.

The server performs file I/O by writing the audio stream to a storage medium (for example, a file system or object storage) and database operations by creating a new record in a management table. In this operation, the server converts the received metadata into normalized database fields, such as user ID, dialect type, scenario ID, prompt sentence text, file path, and a processing status flag.

The server outputs a persistent audio file in storage and a corresponding database record marked as “unprocessed,” which will be used as input to downstream processing.

### Step 6:

The server executes signal processing to produce preprocessed speech data.

The server takes as input the raw audio file referenced by an “unprocessed” database record.

The server performs digital signal processing operations: it reads the waveform samples, applies band-pass filtering to keep only speech-relevant frequencies, applies a noise reduction algorithm (such as spectral subtraction) to reduce background noise, runs a voice activity detector to detect and remove leading and trailing silent intervals, and performs amplitude normalization so that the overall loudness matches a target level. These operations involve Fourier transforms, spectral magnitude modification, thresholding, and scaling.

The server outputs a new preprocessed audio file and updates the database record with a reference to the preprocessed file and a processing status indicating completion of signal preprocessing.

### Step 7:

The server performs automatic speech recognition to obtain character string information including dialect expressions.

The server takes as input the preprocessed audio file associated with the database record.

The server performs feature extraction by computing, for example, mel-frequency cepstral coefficients or mel-spectrogram frames from the waveform, then feeds the feature sequence into an acoustic model (such as a neural network encoder) to obtain frame-level probability distributions over subword units. The server then executes a decoding algorithm, such as beam search with a language model, to convert these probability sequences into the most likely character or token sequence representing the spoken utterance.

The server outputs character string information that may include dialect vocabulary, and stores this recognized text in the database linked to the original audio record.

### Step 8:

The server executes language processing to extract dialect vocabulary and generate dictionary information.

The server takes as input the recognized character string information and the current dialect-standard dictionary table.

The server performs natural language processing, including tokenization and morphological analysis, to segment the character string into tokens. The server then performs lookup operations by comparing each token or token n-gram against entries in the dictionary table. When a dialect token is found, the server reads its mapped standard language counterpart. When an unknown candidate dialect expression is found, the server flags it as a new entry and may assign a provisional mapping or mark it for later annotation. The server thereby computes an updated set of mappings.

The server outputs an original dialect transcription, a normalized standard language transcription generated by substituting mapped tokens, and updated dictionary information, and writes these into the database and dictionary tables.

### Step 9:

The server computes acoustic and prosodic features and associates them with the dictionary information.

The server takes as input the preprocessed audio file, the recognized character string, and any alignment information or time stamps.

The server performs feature extraction operations to calculate acoustic feature vectors (for example, spectra, cepstral coefficients, and energy) and prosodic feature vectors (for example, fundamental frequency trajectories and segment durations) for small time frames. The server then performs an alignment procedure, such as forced alignment, to map each token or phoneme in the character string to a corresponding time interval in the audio. Using this mapping, the server associates specific feature segments with particular dialect tokens and standard tokens in the dictionary.

The server outputs a set of feature sequences stored in feature storage, each indexed by record ID and token ID, and updates the management storage so that these features can be retrieved for training and analysis.

### Step 10:

The server constructs structured training data for the generative AI model.

The server takes as input the dictionary information, the dialect and standard transcriptions, the acoustic and prosodic features, and the prompt sentence associated with each record.

The server performs data aggregation and formatting operations: the server assembles input sequences consisting of special tokens that indicate dialect type, tokens representing the prompt sentence, and tokens representing either dialect or standard text, and it chooses corresponding target text sequences (for example, standard text as the target when dialect text is the source). The server may also compress or encode selected acoustic or prosodic features into auxiliary vectors and attach them to the token sequences.

The server outputs a set of training examples, each consisting of an input sequence and a target sequence, optionally with attached feature vectors, and stores these examples in a training dataset accessible to the training routine.

### Step 11:

The server trains the generative AI model using the structured training data.

The server takes as input the training dataset and an initialized generative AI model (for example, a transformer-based encoder-decoder network with defined layer counts, attention heads, and embedding dimensions).

The server performs iterative numerical computations: for each mini-batch of training examples, the server encodes the input token sequences into embeddings, applies self-attention and feed-forward layers in the encoder and decoder, and computes predicted probability distributions over tokens at each time step. The server computes a loss function, such as cross-entropy between predicted distributions and one-hot encodings of the target tokens, and then performs backpropagation to obtain gradients of the loss with respect to model parameters. The server updates the parameters using an optimization algorithm such as Adam with specified learning rate and regularization, and repeats this process across epochs until validation metrics stabilize.

The server outputs a trained generative AI model whose parameters capture mappings between dialect and standard expressions conditioned on prompt sentences and dialect type, and stores model weights and version information in model storage.

### Step 12:

The server evaluates the generative AI model and adjusts learning conditions.

The server takes as input an evaluation dataset that is disjoint from the training set and the current trained generative AI model.

The server performs inference on evaluation examples by encoding the input sequences and decoding output sequences without updating model weights. The server then computes evaluation indices such as character error rate, word error rate, and BLEU score by comparing generated outputs to reference targets. The server performs statistical analysis on the errors, grouping them by dialect type, vocabulary class, or scenario. When the server detects systematic errors, it modifies learning conditions, such as adjusting learning rate, batch size, or weight decay, or it alters configuration parameters, such as increasing the number of attention heads or layers. The server then re-executes the training procedure with updated settings.

The server outputs updated parameters and, if applied, a re-trained generative AI model with improved performance metrics, and records evaluation results and configuration settings in the management storage.

### Step 13:

The server performs data augmentation for low-resource dialects using the generative AI model.

The server takes as input standard language sentences, prompt sentences specifying a target dialect, and the trained generative AI model.

The server performs generative inference by encoding the standard language and prompt tokens and decoding dialect tokens, thereby generating synthetic dialect expressions. The server then forms pairs of generated dialect sentences and known standard sentences. The server optionally applies filtering operations, such as checking back-translation consistency or using a language identifier, to remove low-quality pairs. The server appends accepted pairs to the training dataset for that dialect.

The server outputs an augmented training dataset that includes both real and synthetic dialect-standard pairs, enabling further training or fine-tuning of the generative AI model for better performance on that dialect.

### Step 14:

The server processes live dialect speech during runtime to generate normalized instruction information.

The server takes as input streaming or chunked preprocessed audio and associated prompt sentences from the terminal, together with a selected generative AI model corresponding to the dialect type.

The server applies incremental speech recognition to the incoming audio and feeds intermediate or final recognized text into the generative AI model, along with the prompt sentence tokens. The server computes a normalized standard language text by decoding from the model, and then parses the normalized text into a structured intent representation, such as an action type and parameters. This involves rule-based or classifier-based parsing operations built on the normalized text.

The server outputs instruction information normalized into standard language and structured as a control command, and transmits this information back to the terminal over the communication network.

### Step 15:

The terminal receives the instruction information and controls applications or devices.

The terminal takes as input the normalized instruction information sent by the server.

The terminal performs an interpretation and control operation: the terminal maps the instruction information to a local function (for example, querying a weather service, setting an alarm, or sending a message) and calls the corresponding application programming interface provided by the operating system or a local application. The terminal may then generate a textual result and, if necessary, use a text-to-speech engine and, optionally, the generative AI model in reverse conversion mode to render a response in the user's dialect.

The terminal outputs a visible and/or audible response to the user and a side effect on the controlled application or device (such as a scheduled alarm or displayed weather information), thereby closing the loop of dialect-aware interaction.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional speech recognition systems are generally optimized for a limited set of standard language patterns and are not well adapted to large variations in pronunciation, prosody, and vocabulary that occur in regional dialects and in the speech of elderly users. In many deployed systems, a front-end device simply captures audio and forwards it to a server, where a generic acoustic model and a generic language model attempt recognition without explicit modeling of dialectal variation, user intent, or subsequent device control. As a result, recognition accuracy for dialectal speech is low, error patterns are difficult to diagnose, and the systems frequently fail in end-to-end tasks such as controlling assistance devices.

Further, existing implementations often treat automatic speech recognition and natural language generation as separate, loosely coupled components. They do not use a generative AI model with explicit prompt sentences to perform dialect-standard language conversion in a structured way. Consequently, these systems do not effectively leverage generative models to normalize dialectal expressions, to generate synthetic dialect data, or to drive continuous improvement of recognition performance across multiple dialects.

Moreover, known architectures lack an integrated feedback loop that relates server-side audio preprocessing, automatic speech recognition, generative conversion, intent extraction, and device control outcomes. Without systematic logging and correlation of recognition results, conversion results, and control results, it is difficult to construct high-quality training corpora for retraining. This limits the ability of the system to improve recognition accuracy and robustness for different regions and user populations over time.

In addition, expansion from one dialect to multiple dialects is typically handled by building independent models or ad hoc rule sets for each new dialect, without a unified processing flow or a prompt-driven generative AI mechanism. This leads to high development and maintenance costs, duplication of effort, and inconsistent performance across dialects. There is therefore a need for a technical framework in which a processor coordinates terminal-side signal enhancement, server-side signal processing, dialect-aware recognition, generative AI-based conversion guided by prompt sentences, semantic analysis, and device control, and in which an integrated feedback learning mechanism continuously improves the models and supports scalable expansion to additional dialects.

Accordingly, there is a demand for a computer-implemented system that improves the underlying computer technology for dialectal speech processing, by (i) structuring the end-to-end pipeline into coordinated processing units executed by a processor, (ii) using a generative AI model with explicit prompt sentences for dialect-standard language conversion and dialect generation, (iii) automatically generating and managing learning data based on real interactions, and (iv) enabling systematic expansion to multiple dialects under a common control and evaluation framework.

The specific processing by the specific processing unit 290 of the data processing device 12 in Application Example 1 is realized by the following means.

The present invention provides a server comprising a processor configured to coordinate acquisition of user utterances from a terminal device, execute server-side signal processing on voice data received via a communication network, execute a voice recognition model to generate character strings including dialectal expressions, generate prompt sentences to be input to a generative AI model, input combinations of the dialectal character strings and the prompt sentences to the generative AI model to convert the dialectal character strings into standard language character strings, extract user intention and target information from the standard language character strings, convert the extracted information into structured control instruction information, generate control messages for assistance devices or information processing devices based on the structured control instruction information, transmit the control messages via a control network, store pairs of prompt sentences and response sentences as learning data for retraining the generative AI model, and record voice recognition results, conversion results by the generative AI model, and device control results in association with one another to extract misrecognition cases and register the misrecognition cases as retraining data for the voice recognition model and the generative AI model. This enables an improved computer-implemented speech processing pipeline in which terminal-side and server-side processing are integrated, dialectal speech is robustly converted into standard language using a generative AI model guided by prompt sentences, user intent is reliably mapped to structured device control commands, training data is automatically generated and managed based on real usage, and recognition performance and dialect coverage are continuously enhanced through feedback learning and scalable model adaptation.

The term “voice data acquisition unit” refers to a functional component, implemented by hardware, software, or a combination thereof, that acquires audio signals representing uttered speech of a user through an audio input device and outputs corresponding digital voice data.

The term “data preprocessing unit” refers to a functional component that receives raw voice data and performs signal processing operations, such as noise suppression, reverberation suppression, volume normalization, and time information addition, to generate preprocessed voice data suitable for subsequent recognition processing.

The term “model training unit” refers to a functional component that uses training data including voice data and associated character information to train or retrain a generative AI model or a voice recognition model by executing a machine learning algorithm on a computing resource.

The term “test evaluation unit” refers to a functional component that evaluates performance of a trained model by applying the model to test data, comparing model outputs with reference data, calculating evaluation metrics, and determining accuracy or error characteristics of the model.

The term “dialect adaptation expansion unit” refers to a functional component that manages expansion of system functionality from support for a particular dialect to support for additional dialects by repeating data acquisition, preprocessing, model training, and evaluation for each dialect and selecting or adapting models accordingly.

The term “terminal process” refers to operations executed by a terminal device, including acquiring a user utterance through an audio input device, applying noise suppression and directivity control to the acquired audio, formatting the resulting voice data, and transmitting the formatted voice data to a server device via a communication network.

The term “audio input device” refers to a transducer or an assembly of transducers, such as a microphone or microphone array, that converts acoustic waves produced by a user's speech into electrical or digital signals for processing.

The term “noise suppression processing” refers to a signal processing operation that reduces or removes undesired background sounds, such as environmental noise or interference, from voice data in order to emphasize a target speaker's utterance.

The term “directivity control processing” refers to a signal processing operation, typically applied to signals from multiple audio input channels, that emphasizes sound from a target direction and attenuates sound from other directions.

The term “communication network” refers to any wired or wireless network infrastructure that enables data transmission between a terminal device and a server device, including local area networks, wide area networks, and public networks.

The term “server-side preprocessing” refers to processing performed by a server device on voice data received from a terminal device, including frequency component processing, reverberation suppression, volume normalization, and time information addition using a signal processing library.

The term “frequency component processing” refers to a digital signal processing operation that modifies or analyzes the spectral characteristics of voice data, such as through filtering or spectral shaping.

The term “reverberation suppression processing” refers to a digital signal processing operation that reduces effects of room reverberation or echo in voice data to improve clarity of speech.

The term “volume normalization processing” refers to a digital signal processing operation that adjusts the amplitude level of voice data to fall within a target loudness range.

The term “time information adding processing” refers to an operation that associates time stamps or temporal indices with voice data segments or tokens, enabling temporal alignment between audio and textual information.

The term “voice recognition model” refers to a computational model, such as a statistical model or a neural network model, that receives voice data as input and outputs a character string or other representation corresponding to recognized speech.

The term “character string including a dialect” refers to textual data output by a voice recognition model that represents recognized speech and contains expressions characteristic of a regional dialect, as opposed to a standardized language form.

The term “prompt sentence” refers to a textual instruction or context string that is input to a generative AI model together with another input, such as a dialectal character string, to guide the model's generation or conversion output.

The term “generative AI model” refers to a machine learning model, typically a neural network such as a transformer-based model, that generates or transforms text in response to input data, and that can perform tasks such as dialect-standard language conversion or dialect text generation.

The term “standard language character string” refers to textual data expressed in a standardized language form, obtained by converting a character string including a dialect into a standardized representation.

The term “semantic analysis unit” refers to a functional component that receives a standard language character string and identifies user intention, target objects, and other semantic elements, and outputs structured information representing the identified semantics.

The term “structured control instruction information” refers to data representing user intention and target information in a predefined format, such as a set of fields or a data structure, suitable for direct use in device control.

The term “device control unit” refers to a functional component that receives structured control instruction information, maps it to a protocol-specific control message, and transmits the control message to an assistance device or an information processing device via a control network.

The term “assistance device” refers to any physical apparatus used to provide support or assistance to a user, such as a robotic apparatus, an actuator system, or a controllable home appliance.

The term “information processing device” refers to any computing or electronic device that processes information and can be controlled by digital commands, such as a terminal, a display device, or a control gateway.

The term “control network” refers to a communication infrastructure used for transmitting control messages between a server device and one or more controlled devices, and may include wired or wireless links and standardized or proprietary protocols.

The term “learning data management unit” refers to a functional component that stores, organizes, and maintains learning data, including pairs of prompt sentences and response sentences or other input-output pairs, for use in training or retraining models.

The term “response sentence” refers to a textual output generated by a generative AI model in response to a prompt sentence and, optionally, additional input text.

The term “feedback learning unit” refers to a functional component that records voice recognition results, generative conversion results, and device control results, analyzes these records to detect misrecognition cases, and registers the misrecognition cases as retraining data for one or more models.

The term “misrecognition case” refers to an instance in which an output produced by a voice recognition model or a generative AI model does not correctly represent the user's utterance or intention, as determined by reference data, user feedback, or device control outcome.

The term “retraining data” refers to data sets, including input-output pairs and associated labels, used to further train or fine-tune an already trained model to improve its performance.

The term “terminal device” refers to an end-user device, such as a portable communication device, a dedicated user interface device, or a robotic platform, that acquires user utterances and communicates with a server device.

The term “server device” refers to a computing apparatus, which may include one or more processors and memory devices, that receives voice data from a terminal device, executes signal processing, recognition, generative AI, and control functions, and communicates with controlled devices and data stores.

In the following embodiments, a server, a terminal, and a user cooperate to implement the claimed system. A person having ordinary skill in the art can modify hardware and software components without departing from the spirit of the invention.

### A. Overall Architecture

The server executes a plurality of functional units, including a voice data acquisition unit (on the server side interface), a data preprocessing unit, a model training unit, a test evaluation unit, a dialect adaptation expansion unit, a semantic analysis unit, a device control unit, a learning data management unit, and a feedback learning unit. The server includes at least one general-purpose processor (for example, a multi-core CPU), at least one accelerator (for example, a graphics processing unit), a main memory, a network interface, and a non-volatile storage device.

The terminal includes an audio input device, a local processor (for example, a system-on-chip), a memory, a network interface, and optionally one or more actuators or user interface elements such as a display and a loudspeaker. The terminal executes a terminal process that acquires user utterances, performs local signal enhancement, and transmits processed audio to the server.

The user interacts with the system by speaking in a natural dialectal manner to the terminal. The user does not need to be aware of the internal structure of the server or the terminal.

### B. Terminal-Side Configuration

The terminal uses a high-sensitivity microphone or microphone array as the audio input device. In one embodiment, the terminal includes a microphone array connected to a digital signal processor within a system-on-chip. The terminal samples the user's speech at, for example, 16 kHz and 16 bits per sample, and stores the samples in a circular buffer in memory.

The terminal applies noise suppression processing and directivity control processing to the sampled data. The terminal uses, for example, a short-time Fourier transform implemented in firmware or in a software library function to obtain spectral features. The terminal estimates noise spectra from non-speech segments and subtracts or attenuates the noise spectra from the mixed spectra. The terminal then applies beamforming algorithms to combine channels of the microphone array in a directionally selective manner. The terminal determines a steering vector corresponding to the position of the user and multiplies each channel by a complex weight. This processing reduces interference from other speakers and environmental noise.

The terminal packetizes the enhanced audio samples into frames of fixed duration, such as 20 milliseconds, and attaches a local timestamp to each frame using a high-resolution clock of the system-on-chip. The terminal transmits the frames over a communication network to the server by using a transport protocol such as a persistent connection. This arrangement reduces the computational burden on the server for low-level signal enhancement and reduces network load by transmitting only enhanced and compressed audio.

### C. Server-Side Preprocessing

The server receives the enhanced audio frames from the terminal via the network interface. The server reorders the frames based on timestamps, reconstructs continuous audio segments, and stores the segments in memory buffers.

The server applies server-side preprocessing to the reconstructed audio. The server uses a signal processing library to perform frequency component processing, reverberation suppression processing, and volume normalization processing. For example, the server applies a band-pass filter to eliminate frequency components that are irrelevant to human speech, thereby improving the signal-to-noise ratio for the subsequent recognition model. The server then applies dereverberation processing by estimating a room impulse response from the observed signal and inverting or compensating for the impulse response in the spectral domain. The server normalizes per-segment loudness based on root-mean-square values or perceptual loudness metrics, thereby providing uniform input conditions to the recognition model.

The server assigns precise time information to each segment by using a server-side clock, which is more stable and coordinated across sessions than the terminal clock. This allows the server to align recognition outputs with audio segments for later analysis and feedback learning. The server stores the preprocessed audio and associated time labels in a structured data store.

This preprocessing configuration improves computational efficiency and accuracy because the recognition model receives input that is normalized across terminals and recording environments. The server avoids re-implementing terminal-side processing and focuses on global, computationally heavier operations that benefit from the server's processing power.

### D. Voice Recognition and Dialectal Transcript Generation

The server executes a voice recognition model on the preprocessed audio. In one embodiment, the server uses a neural network architecture consisting of a stack of convolutional layers for feature extraction, a sequence of recurrent or transformer layers for temporal modeling, and a final linear projection for output logits over a character or subword vocabulary. The server uses a loss function such as connectionist temporal classification during training. During inference, the server uses beam search to obtain the most probable sequence.

The server outputs a character string including a dialect. For example, when the user utterance corresponds to a command in a particular dialect, the server generates a textual recognition such as:
“Bring me some tea” (spoken in a Tsugaru dialect)
   or:
“Turn on the TV” (spoken in a Tsugaru dialect)

The server associates each character or token with start and end times by aligning the recognition result with the audio frames. The server stores the dialectal string and timing information in a database in association with the audio segment.

This architecture improves recognition performance for dialectal speech by enabling the model to handle variable-length inputs and by directly optimizing an error function that is tolerant to alignment variations. The use of a subword vocabulary reduces out-of-vocabulary errors, particularly for dialectal expressions not present in conventional word lists.

### E. Generative AI Model and Prompt-Based Dialect-Standard Conversion

The server employs a generative AI model, implemented as a neural network having an encoder-decoder transformer architecture. The encoder receives input tokens representing a prompt sentence and the recognized dialect string. The decoder receives encoder outputs and generates tokens representing a standard language character string.

The server constructs a prompt sentence to guide conversion. For example, the server uses prompt sentences such as:
“Please translate the following Tsugaru dialect sentence into standard Japanese. Sentence: “Bring me some tea.””
“Please translate the following Tsugaru dialect sentence into standard Japanese. Sentence: “Turn on the TV.””

The server tokenizes the prompt sentence and the dialect string, concatenates the tokens into a single sequence with segment markers, and inputs the sequence to the generative AI model. The server then decodes the model output using a beam search or sampling-based decoding method to produce the most probable standard language character string, such as:
“Please bring me some tea.”
or:
“Please turn on the TV.”

This prompt-based arrangement imposes an explicit task specification on the generative AI model. The server can easily vary the prompt to switch between dialect-standard conversion and standard-dialect generation. For example, the server may use prompt sentences such as:
“How do you say “Please bring me some tea” in Tsugaru dialect?”
“How do you say “Please turn on the TV” in Kagoshima dialect?”

The server uses the generative AI model to output dialect expressions for these prompts and stores the outputs as candidate training examples. Because the prompt explicitly encodes requested direction and dialect, the internal attention mechanisms of the neural network learn to condition on dialect identifiers and task description, which reduces ambiguity and enables a single model to handle multiple dialects and conversion tasks.

This prompt-based control of the generative AI model constitutes an improvement to computer technology. The server achieves higher conversion accuracy with fewer models by unifying multiple dialect tasks under a single, prompt-conditioned architecture. The server also obtains synthetic training data in a structured manner without requiring human rule authoring for each dialect.

### F. Semantic Analysis and Structured Control Instruction Generation

The server performs semantic analysis on the standard language character string. In one embodiment, the server uses a neural network classifier that operates on token embeddings produced by a transformer encoder. The server trains this classifier to output an intent label, such as “BRING_ITEM” or “TURN_ON_DEVICE,” and associated slot values, such as an item name or a device type.

The server constructs a structured control instruction data object with fields representing intent, target object, optional location, and priority. The server stores the data object in memory and also persists it in the database in association with the session identifier.

The use of a structured data object allows the server to apply rule-based or learned mapping to device-specific control protocols. This reduces coupling between language processing and device control, and allows new devices to be integrated by defining mappings from the structured format to device commands without retraining the recognition model.

### G. Device Control and Real-World Actuation

The server generates a device control message based on the structured control instruction. The device control message includes fields such as a device identifier, an operation code, and parameters. The server transmits the device control message over a control network to an assistance device or an information processing device.

In a typical example, the assistance device is a robotic apparatus in a care environment. When the standard language character string corresponds to “Please bring me some tea.”, the server generates a command instructing the robot to retrieve a beverage from a predefined location and deliver it to the user. The robotic apparatus interprets the command, plans a path, and actuates motors to move.

When the standard language character string corresponds to “Please turn on the TV.”, the server generates a command for a multimedia device or a home gateway that relays an infrared or digital control signal to a television to turn it on.

Because the system is configured to output standardized control messages independent of individual dialect variations, the same device control mechanism can operate reliably even when users from different regions speak different dialects. The linkage of recognition and conversion to actual actuation demonstrates that the invention is not limited to abstract data manipulation but is tied to control of physical devices in the real world.

### H. Learning Data Management and Feedback Learning

The server accumulates learning data across sessions. The server stores triplets consisting of (recognized dialect string, prompt sentence, generative AI model output) and triplets consisting of (audio, dialect string, standard string). The server also stores structured control instructions and corresponding device outcomes (success or error signals).

The server analyzes stored data to detect misrecognition cases. For example, the server compares the intended action as confirmed by a human operator or by device state with the action derived from the recognition and semantic analysis pipeline. When a discrepancy occurs, the server marks the associated data as a misrecognition case.

The server registers misrecognition cases as retraining data. For voice recognition, the server uses pairs of (audio, correct transcription). For conversion, the server uses pairs of (prompted input, correct standard string). The server then retrains or fine-tunes the models using gradient-based optimization algorithms. The server computes an error function such as cross-entropy loss for each training pair, computes gradients of the loss with respect to model parameters, and updates parameters using a variant of stochastic gradient descent.

The server may perform data augmentation, such as adding noise or altering pitch of the audio, to improve robustness of the recognition model. For the generative AI model, the server may alter prompt sentences by using synonyms or changing word order while preserving meaning, in order to encourage the model to handle a broader spectrum of instructions.

This feedback learning mechanism improves computer performance over time by reducing error rates and increasing robustness across conditions. The mechanism operates at a level of detail and scale that is not practical for human manual processing, thereby providing a technical improvement beyond mere automation of a mental process.

### I. Dialect Adaptation Expansion

The server manages expansion from support for a primary dialect to multiple dialects. For each new dialect, the server directs the voice data acquisition unit and the terminal to collect speech data from users in the target region. The server then applies the same preprocessing pipeline, recognition and conversion steps, and semantic analysis steps.

The dialect adaptation expansion unit controls evaluation across candidate model configurations, such as a single unified generative AI model handling all dialects, or dialect-specific models. The server compares evaluation metrics such as word error rate and intent detection accuracy for each configuration and selects the most effective configuration for deployment. The server then adjusts prompt sentences, for example by specifying dialect names or characteristic expressions, to ensure that the generative AI model properly distinguishes dialectal contexts.

For example, when adding a new regional dialect for climate control commands, the server may introduce prompt sentences such as:
“How do you say “Please turn off the air conditioner” in Kagoshima dialect?”

The server uses outputs of the generative AI model for such prompts as synthetic training data and validates them. The combination of prompt-controlled generation, evaluation, and configuration selection enables efficient expansion without manually crafting rules for each dialect.

### J. Technical Effects and Improvements

The server improves computer technology by interconnecting specialized data structures, models, and processing steps. The use of standardized audio frame formats, time-aligned token sequences, prompt-based generative conversion, and structured control instructions allows the server to reduce computational redundancy and communication overhead. For example, by performing noise suppression and beamforming at the terminal, the system reduces the volume of low-quality data transmitted; by applying centralized normalization, the server reduces model variance and improves recognition speed and accuracy.

The generative AI model, designed as a prompt-conditioned transformer, allows the server to handle various dialect conversion tasks within a single parameter set. The server therefore avoids maintaining separate rule engines or model instances for each dialect, which reduces memory usage and allows more efficient use of accelerator resources. The continuous feedback learning mechanism creates an automatic, machine-driven optimization loop that adjusts models in response to real operational data, thereby reducing the need for manual reconfiguration and enabling the system to achieve accuracy levels that exceed traditional rule-based or single-dialect models.

The invention thus provides concrete improvements to processing speed, recognition precision, error analysis, and model adaptability. The architecture integrates speech recognition, generative AI conversion, semantic analysis, and device control in a technically specific manner, including detailed data processing and model training procedures, thereby realizing a practical and non-abstract application of computer and AI technology.

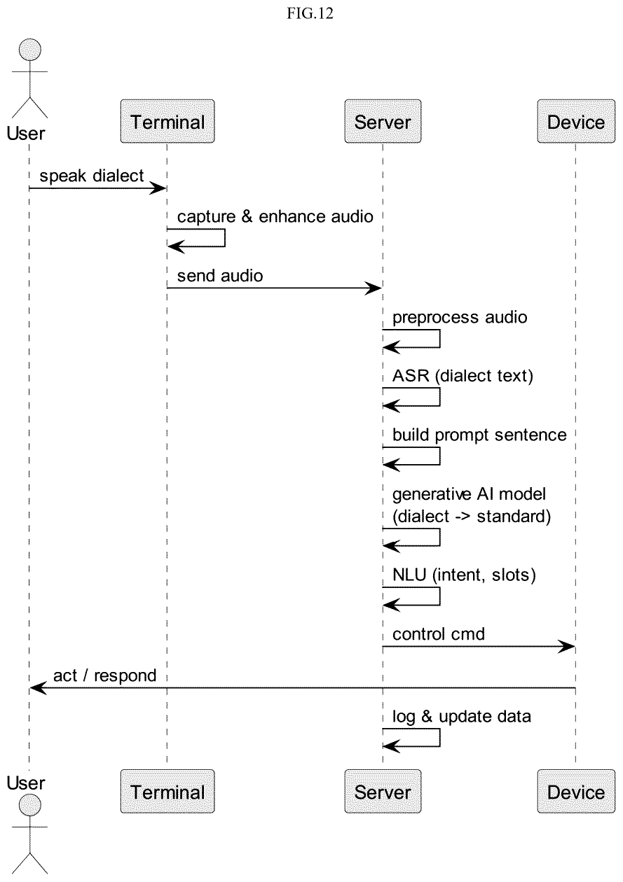

The following describes the processing flow using FIG. 12.

### Step 1:

The user speaks a command in a dialect toward the terminal.

The user inputs an acoustic signal corresponding to a natural utterance, such as
“Bring me some tea (in Tsugaru dialect)” or “Turn on the TV. (in Tsugaru dialect),” in a caregiving environment. The output of this step is an analog sound wave in the air around the terminal.

### Step 2:

The terminal acquires the analog sound wave and converts it to digital audio frames. The terminal receives the analog sound wave as input through a microphone or microphone array and performs analog-to-digital conversion at, for example, 16 kHz and 16-bit resolution. The terminal applies local buffering, groups samples into short frames (for example, 20 ms), and attaches local timestamps using an internal clock. The output of this step is a sequence of time-stamped digital audio frames representing the user's utterance.

### Step 3:

The terminal performs noise suppression and directivity control on the audio frames and transmits the processed frames to the server.

The terminal takes the time-stamped audio frames as input and executes signal processing operations, including spectral analysis, noise estimation and subtraction, and beamforming using the microphone array. Based on these operations, the terminal attenuates environmental noise and emphasizes sound from the user's direction. The terminal optionally encodes the frames using an audio codec to reduce size and then sends the encoded frames over a communication network to the server. The output of this step is a stream of enhanced, time-stamped audio frames delivered to the server.

### Step 4:

The server receives, buffers, and reconstructs continuous audio segments from the incoming frames.

The server takes the enhanced audio frames as input through a network interface and stores them in a receive buffer according to their timestamps and session identifiers. The server reorders frames if necessary and concatenates them to form continuous audio segments corresponding to each utterance. The server records the segment boundaries and session metadata in a data structure. The output of this step is a set of continuous, session-indexed audio segments stored in server memory or storage.

### Step 5:

The server performs frequency component processing, reverberation suppression, and volume normalization on each audio segment.

The server takes a continuous audio segment as input and computes its frequency representation using a transform such as a short-time Fourier transform. Using this representation, the server applies band-pass filtering to remove frequency components outside the speech band, estimates reverberation characteristics, and applies dereverberation to reduce echoes. The server then calculates the energy of the segment and scales the waveform so that its loudness falls within a target range. The server adds precise server-side timestamps for alignment. The output of this step is a preprocessed audio segment with normalized spectral characteristics and associated timing information.

### Step 6:

The server executes a voice recognition model on the preprocessed audio segment and generates a dialectal character string with timing information.

The server takes the preprocessed audio segment as input and converts it into acoustic feature vectors, such as Mel-frequency cepstral coefficients or log-Mel filterbank features. The server feeds these feature vectors into a trained neural network-based voice recognition model and applies a decoding algorithm (for example, beam search) to compute the most probable sequence of characters or subword units. The server aligns the decoded sequence with the input frames to assign start and end times to each token. The output of this step is a recognized character string including dialectal expressions, together with token-level timing information.

### Step 7:

The server generates a prompt sentence and combines it with the dialectal character string as input to a generative AI model.

The server takes the dialectal character string as input and constructs a text instruction describing the desired conversion. For example, the server generates a prompt sentence such as “Please translate the following Tsugaru dialect sentence into standard Japanese. Sentence: “Bring me some tea.”” or “Please translate the following Tsugaru dialect sentence into standard Japanese. Sentence: “Turn on the TV.”.” The server concatenates the prompt sentence and the dialectal character string into a single text sequence with appropriate separators and tokenizes the sequence. The output of this step is a tokenized sequence that encodes both the prompt sentence and the dialectal content.

### Step 8:

The server executes the generative AI model on the tokenized sequence to obtain a standard language character string.

The server takes the tokenized prompt-plus-dialect sequence as input and processes it through a transformer-based generative AI model, performing attention computations and iterative decoding to predict output tokens. Using a decoding strategy such as beam search, the server selects the most probable target token sequence and converts it back to text. The server thereby transforms, for example, “Bring me some tea (in Tsugaru dialect).” into “Please bring me some tea.” and “Turn on the TV (in Tsugaru dialect).” into “Please turn on the TV.” The output of this step is a standard language character string associated with the original dialectal utterance.

### Step 9:

The server performs semantic analysis on the standard language character string and generates structured control instruction information.

The server takes the standard language character string as input and converts it into a sequence of tokens or embeddings for use by a semantic analysis model. The server applies an intent classification and slot-filling algorithm to determine the user's intent (for example, “BRING_ITEM” or “TURN_ON_DEVICE”) and to extract relevant entities such as an item name or a device type. Based on these results, the server constructs a structured data object containing fields for intent, target entity, optional parameters, and context. The output of this step is structured control instruction information suitable for device control.

### Step 10:

The server generates a device control message from the structured control instruction information and transmits the message over a control network.

The server takes the structured control instruction information as input and maps its fields to a device-specific command format. The server selects an appropriate protocol and destination address for the target assistance device or information processing device. The server then encodes the command, including a device identifier, an operation code, and parameters, into a message conforming to the selected protocol and sends the message via the control network interface. The output of this step is a transmitted device control message that can be interpreted by the target device.

### Step 11:

The terminal or an associated device receives the control message and executes the requested operation, optionally providing feedback to the user.

The terminal or the controlled device takes the control message as input, decodes the operation code and parameters, and invokes internal control logic to perform the requested action, such as moving a robotic apparatus to fetch an item or turning on a display device. The terminal may additionally receive a confirmation status from the device and generate a spoken confirmation using a text-to-speech engine, playing a phrase such as “I will bring you tea.” or “I will turn on the TV.” through a loudspeaker. The output of this step is the physical actuation of the device in the real world and, when used, an audible confirmation for the user.

### Step 12:

The server records recognition results, generative conversion results, and control outcomes and updates learning data for future model training.

The server takes as input the recognized dialectal character string, the prompt sentence, the standard language character string, the structured control instruction information, and the device control result (success or failure). The server writes these elements into a persistent storage structure as a linked record for the session. The server analyzes the stored records to detect misrecognition or miscontrol cases and extracts corresponding data as labeled training examples. The server then adds these examples to training datasets for the voice recognition model and the generative AI model, to be used in subsequent retraining operations. The output of this step is an updated set of learning data that reflects real-world usage and errors, enabling continuous improvement of recognition and conversion performance.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional speech interfaces that rely on general-purpose automatic speech recognition models and rule-based dialogue engines often exhibit low robustness when handling non-standard speech, such as regional dialects and individual speaking styles. In many deployments, the acoustic models and language models are primarily optimized for a standard language variety, and therefore produce high recognition error rates for dialectal vocabulary, pronunciation, and prosody. Furthermore, conventional systems typically treat emotion as an optional post-processing attribute, if at all, and do not integrate emotional state estimation into the core recognition and response generation pipeline. As a result, the system is unable to adaptively change response content, style, and tone based on the user's emotional condition.

From a computer-technology perspective, these limitations manifest as technical inefficiencies and deficiencies in the way computing resources process and utilize multimodal information. First, the speech recognition pipeline does not efficiently leverage dialect information and prosodic features, leading to redundant retries, unnecessary user clarifications, and degraded throughput of the recognition engine. Second, separate and loosely coupled components for recognition, sentiment analysis, and response generation cause duplicated feature extraction and fragmented data flows, increasing latency and computational overhead. Third, dialogue generation modules, where present, frequently use generic, template-based responses, which prevents the system from exploiting the full expressiveness and conditioning capabilities of modern generative AI models.

In addition, existing systems do not systematically capture and reuse the rich intermediate data generated during dialogue, such as dialectal transcriptions, standard-language conversions, estimated emotions, and the prompt sentences fed to generative models. Without integrated management of this information as training data, model updates and personalization require costly manual data curation and ad hoc labeling processes, thereby limiting continuous improvement of the underlying machine learning models.

Consequently, there is a need for a computer-implemented system that tightly integrates (i) dialect-aware signal processing and language processing, (ii) emotion-aware user state estimation, and (iii) prompt-based generative response synthesis, and that manages the associated data in a structured way for iterative model training. Such a system should improve the technical performance of speech interfaces by reducing recognition errors for dialectal speech, decreasing end-to-end latency, improving the contextual appropriateness of generated responses, and enabling more efficient training and updating of speech recognition and emotion estimation models.

The specific processing by the specific processing unit 290 of the data processing device 12 in Example 2 is realized by the following means.

The present invention provides a server comprising a processor configured to execute an audio data acquisition function, a signal processing function, a language processing function, an emotion estimation function, a prompt generation function, a response generation function, a response verification function, an output control function, a learning data management function, and a model learning function, the processor being further configured to: process incoming audio signals from a client device to generate acoustic feature values normalized with respect to dialect-specific characteristics; convert the acoustic feature values into a first text sequence including dialect expressions and into a second text sequence in a standard language while generating dialect information; estimate, based on the acoustic feature values and the dialect information, an emotional state of a user as structured data; construct a prompt sentence in natural language for a generative AI model by embedding at least the first text sequence, the second text sequence, the estimated emotional state, and dialogue scenario information into a prompt template that defines generation conditions for a response sentence; cause the generative AI model to generate, in accordance with the prompt sentence, a response sentence in a target dialect and response style; verify the generated response sentence for inappropriate content or semantic inconsistency and, based on a verification result, select or regenerate the response sentence; control transmission and presentation parameters of the selected response sentence to the client device; and store the audio data, the first text sequence, the second text sequence, the emotional state, the prompt sentence, and the response sentence in association as training data, and update parameters of a speech recognition model and an emotion estimation model using the stored training data and auxiliary data produced by the generative AI model. This enables the computing system to more efficiently and accurately process dialectal speech and emotional cues, reduce recognition errors and response latency, generate contextually appropriate and emotionally adapted responses via a generative AI model driven by explicit prompt sentences, and continuously improve the underlying models through integrated, machine-generated training data, thereby improving the overall performance and robustness of the computer-implemented speech interface.

The term “audio data acquisition unit” refers to a functional component implemented by execution of computer-executable instructions on a processor, the component being configured to obtain audio data representing speech of a user from an input device such as a microphone and to supply the obtained audio data to subsequent processing components.

The term “signal processing unit” refers to a functional component implemented by execution of computer-executable instructions on a processor, the component being configured to perform digital signal processing on audio data, including at least noise reduction, reverberation suppression, level normalization, and frequency characteristic correction, to generate a processed audio signal or acoustic feature values suitable for further analysis.

The term “language processing unit” refers to a functional component implemented by execution of computer-executable instructions on a processor, the component being configured to execute speech recognition using a speech recognition model, to convert a processed audio signal or acoustic feature values into a text sequence, to convert dialect expressions contained in the text sequence into a standard-language text sequence, and to generate dialect information associated with the text sequence.

The term “acoustic feature values” refers to numerical feature representations derived from audio data, including at least frame-wise features such as mel-spectrogram values, cepstral coefficients, fundamental frequency, energy, and temporal prosodic indicators, which are used as input to machine learning models for speech recognition and emotion estimation.

The term “dialect expressions” refers to linguistic expressions, including words, phrases, pronunciations, and prosodic patterns, that deviate from a predetermined standard language and are characteristic of a regional or social dialect variety.

The term “standard language” refers to a language variety that is defined as a reference form of a language for use in public communication, education, administration, or broadcasting, and that serves as a normalization target for converting dialect expressions into a unified representation.

The term “dialect information” refers to structured data associated with recognized speech that indicates at least a dialect type, one or more detected dialect expressions, and optionally prosodic or phonological characteristics specific to a dialect.

The term “emotion estimation unit” refers to a functional component implemented by execution of computer-executable instructions on a processor, the component being configured to input acoustic feature values and dialect information into an emotion estimation model and to output a representation of a user's emotional state, such as a categorical label or a continuous score.

The term “emotional state” refers to information representing a psychological or affective condition of a user, including at least one of discrete categories such as joy, anger, sadness, anxiety, confusion, or calmness, or continuous values mapped to such categories.

The term “prompt generation unit” refers to a functional component implemented by execution of computer-executable instructions on a processor, the component being configured to construct a prompt sentence in natural language for conditioning a generative AI model, by embedding recognized text, standard-language text, emotional state information, dialect information, and dialogue scenario information into a prompt template that specifies generation conditions.

The term “prompt sentence” refers to a natural-language text input that is supplied to a generative AI model and that specifies at least a role of the model, a target output language or dialect, a desired number and style of sentences, and an intended emotional or conversational goal, thereby constraining and guiding the model's output.

The term “generative AI model” refers to a machine learning model, typically implemented as a neural network such as a transformer-based language model, that is configured to generate natural-language text or other data in response to an input prompt sentence and optional conditioning information.

The term “response generation unit” refers to a functional component implemented by execution of computer-executable instructions on a processor, the component being configured to provide a prompt sentence to a generative AI model, to obtain from the model a generated response sentence, and to output the response sentence in accordance with conditions specified by the prompt sentence.

The term “response sentence” refers to a natural-language sentence generated by a generative AI model in response to a prompt sentence, the response sentence being intended for presentation to a user and being expressed in a specified dialect or standard language with a specified style and emotional tone.

The term “response verification unit” refers to a functional component implemented by execution of computer-executable instructions on a processor, the component being configured to analyze a generated response sentence to detect at least inappropriate expressions, policy violations, or semantic inconsistencies, and to determine whether to accept the response sentence or request regeneration.

The term “output control unit” refers to a functional component implemented by execution of computer-executable instructions on a processor, the component being configured to control transmission of a response sentence to a client device and to manage presentation parameters such as font size, display contrast, and speech synthesis parameters for output on a display device and a speech synthesis device.

The term “learning data management unit” refers to a functional component implemented by execution of computer-executable instructions on a processor, the component being configured to store and manage, in association, audio data, text sequences including dialect expressions, standard-language text sequences, emotional state information, prompt sentences, and response sentences as training data for machine learning models.

The term “model learning unit” refers to a functional component implemented by execution of computer-executable instructions on a processor, the component being configured to train or update parameters of machine learning models, including at least a speech recognition model and an emotion estimation model, by using training data managed by the learning data management unit and auxiliary data generated by a generative AI model.

The term “client application” refers to a software program executed on a portable or stationary information processing device, the program being configured to control acquisition of audio data from an input device, to package the audio data with metadata, and to communicate with a server over a communication network.

The term “portable information processing device” refers to a handheld or mobile computing device, such as a smartphone or tablet, that includes at least a processor, a memory, a microphone, a display, and a communication interface capable of executing a client application and interacting with a server.

The term “stationary information processing device” refers to a non-portable computing device, such as a desktop computer or a set-top device, that includes at least a processor, a memory, an input device, a display, and a communication interface capable of executing a client application and interacting with a server.

The term “metadata” refers to structured data associated with audio data, including at least user identification information, dialect identification information, scenario identification information, device information, and timestamps, which are used for processing control and learning data management.

The term “encrypted communication protocol” refers to a communication protocol that applies cryptographic techniques to protect data transmitted over a network, ensuring confidentiality and integrity of audio data and metadata exchanged between a client device and a server.

The term “speech recognition model” refers to a machine learning model configured to map acoustic feature values derived from audio data to text sequences representing recognized speech, including dialect expressions, and optionally conditioned on dialect-related information.

The term “emotion estimation model” refers to a machine learning model configured to map acoustic feature values and optionally language-based features or dialect information to an output representing an estimated emotional state of a user.

The term “dialogue scenario information” refers to data representing a contextual setting or task for a dialogue, such as categories including medical support, device operation guidance, or casual conversation, which is used to determine response style and content.

The term “intent information” refers to data derived from text representing a user's utterance, the data indicating a communicative goal or request of the user, such as asking for information, requesting assistance, expressing concern, or engaging in small talk.

The term “dialogue history information” refers to accumulated data representing prior turns in a dialogue, including past user utterances, system responses, emotional states, and prompt sentences, used to provide context for generating subsequent responses.

The term “pseudo data” refers to synthetic training data generated by a generative AI model or other automated process, the data including, for example, dialect text and associated emotional expressions that are used as additional training examples for machine learning models.

In one embodiment, a server implements the claimed system as software modules executed on one or more processors and cooperating with a plurality of terminals over a communication network.

The server executes an operating system such as a general-purpose server OS, and runs an application layer including a web framework (for example, a generic web application framework), a data management system (for example, a relational database management system), and a machine learning framework (for example, a numerical computation framework capable of running neural networks). The server further uses signal processing libraries (for example, a digital audio analysis library, a scientific computation library, a fundamental frequency analysis library) to implement the signal processing unit, and uses a deep learning library (for example, a tensor-based neural network library) to implement a speech recognition model, an emotion estimation model, and a generative AI model interface.

The terminal executes a client application on a mobile operating system or a desktop operating system. The terminal includes a processor, a memory, a microphone, a speaker, a display, and a wireless or wired communication interface. The terminal uses platform-standard audio APIs (for example, a mobile audio recording API), a text-to-speech API, and, optionally, an audio codec library (for example, a multimodal media codec library) to acquire audio data, compress the audio data, and render synthesized speech.

The user interacts with the system by operating the terminal and speaking into the microphone in a dialect. The user may, for example, use a regional dialect to ask for help about visiting a hospital or operating a communication device. The user hears or reads responses output by the terminal and can continue the conversation naturally.

The server implements the audio data acquisition unit by exposing an application programming interface endpoint. The terminal calls this endpoint to upload compressed audio data and associated metadata. The metadata includes, as structured fields, user identification information, dialect identification information, scenario identification information, terminal type, and timestamps. By encoding these fields into a formal data structure, the server can efficiently index, retrieve, and correlate audio records and dialogue context. This design reduces lookup cost during later model training and dialogue management, thereby improving data management performance.

The server implements the signal processing unit using numerical libraries operating on arrays. The server reads compressed audio files from storage, decodes them into time-domain waveforms, and applies a chain of digital filters and learned denoising models. In one implementation, the server applies a pre-emphasis filter, then computes a short-time Fourier transform (STFT). The server estimates noise spectra from non-speech segments using, for example, a minimum statistics algorithm, and performs spectral subtraction to suppress background noise. The server also applies dereverberation based on multi-frame linear prediction or a neural dereverberation network trained on room impulse responses.

The server further computes frame-level energy and rejects frames whose energy falls below a threshold to trim leading and trailing silence. Because the server normalizes loudness and frequency characteristics at this stage, the subsequent neural networks receive inputs with reduced dynamic range variations. This normalization enhances numerical stability in the neural network layers, reduces the risk of gradient explosion or vanishing during training, and improves recognition and emotion estimation accuracy.

The server implements the acoustic feature extraction as part of the signal processing unit. The server segments the cleaned waveform into overlapping frames using, for example, a 25 millisecond window with a 10 millisecond shift, and applies a window function. The server then computes mel-spectrograms by applying a discrete Fourier transform, mapping the power spectrum to a mel filterbank, and taking a logarithm. The server also computes cepstral coefficients (for example, mel-frequency cepstral coefficients), fundamental frequency tracks using a pitch estimation algorithm, and additional prosodic features such as speech rate and pause duration. The server arranges these features into a time-major tensor with dimensions corresponding to time steps, feature channels, and batch index. This structured representation reduces redundancy and allows efficient batch processing on a graphics processing unit.

The server implements the language processing unit as a combination of a neural network-based speech recognition model and a dialect-to-standard conversion component. In one embodiment, the server uses an end-to-end speech recognition model with a transformer or conformer encoder, optionally combined with a CTC (connectionist temporal classification) or attention-based decoder. The server inputs the mel-spectrogram tensor and a dialect embedding vector into the encoder. The dialect embedding vector is selected from an embedding matrix based on the dialect identification information, and is either added to the acoustic feature vectors or concatenated as an additional feature channel.

The server performs a forward pass through the speech recognition model to compute posterior probabilities over token units such as characters or subword units at each time step. The server then applies beam search decoding, maintaining multiple candidate sequences, and uses a scoring function that combines acoustic log-probabilities, language model scores, and a length penalty. This decoding algorithm reduces recognition errors for dialect speech compared to greedy decoding. Because the model is explicitly conditioned on dialect embeddings, the acoustic and language models can better disambiguate dialect-specific pronunciations and lexemes, yielding a first text sequence that faithfully reflects dialect expressions.

The server converts dialect expressions to standard language using a dialect lexicon and optional context-sensitive rules. The server tokenizes the first text sequence into lexical units, then queries a dictionary table that maps dialect tokens to one or more standard-language tokens. In ambiguous cases, the server evaluates candidate replacements using a probabilistic language model trained on standard-language corpora. The server thus generates a second text sequence in the standard language while preserving the overall meaning of the original utterance. The server stores the alignment between dialect tokens and standard tokens in a structured table. This parallel lexicon is later used to refine the recognition model and to generate additional training examples, improving the model's ability to handle less frequent dialect terms.

The server implements the emotion estimation unit as a neural network that consumes both acoustic feature sequences and dialect information. In one embodiment, the server uses a stack of bidirectional recurrent layers or transformer encoder layers followed by pooling and fully connected layers. The server feeds the acoustic feature tensor into the encoder, obtains a sequence of hidden state vectors, and applies attention-based pooling to compute an utterance-level representation. The server concatenates this representation with a dialect embedding vector and, optionally, with features derived from the second text sequence (such as sentiment indicators from a sentiment lexicon). The concatenated vector is fed into dense layers with nonlinear activation functions and a final softmax layer in the classification case, or into a regression head in a continuous-valued case.

The server trains the emotion estimation model using a loss function such as cross-entropy for categorical labels. During training, the server performs backpropagation to compute gradients of the loss with respect to the model parameters and uses a gradient-based optimizer (for example, a variant of stochastic gradient descent with momentum or adaptive learning rate) to update the weights. The server may apply regularization techniques, such as dropout and weight decay, to reduce overfitting. By integrating dialect embeddings into the model input, the server allows the network to learn dialect-specific prosodic patterns that correlate with emotion, which improves emotion classification accuracy over models that ignore dialect information.

The server implements the prompt generation unit as a template-based natural language generation component. The server maintains a set of prompt templates, each describing a task for the generative AI model, including: a role description for the model, a target dialect or language, an expected number of sentences, a stylistic tone, and an emotional objective. The server selects an appropriate template based on intent information extracted from the second text sequence, the estimated emotional state, the dialect type, and dialogue history information. The intent information may be produced by a separate classifier or by rule-based keyword detection. Dialogue history information includes prior system responses, prior user utterances, and prior emotional states.

The server then fills slots in the selected template with the first text sequence (dialect text), the second text sequence (standard text), and other context data. For example, for a user who is anxious about a hospital visit and speaks a regional dialect, the server generates one of the following prompt sentences:
“You are a gentle support AI that speaks a regional dialect. The user, sounding a bit anxious, said: ‘I'm goin to the hospital tomorrow and I'm a little scared.’. Generate exactly one short sentence in natural regional dialect that reassures the user and makes them feel more at ease.”

For a user who is confused about device operation in another regional dialect, the server may generate:
“You are an elderly-friendly support AI that speaks a regional dialect. The user said: ‘I don't know how to use this’ and looks confused about how to use their device. Generate exactly two polite and kind sentences in natural regional dialect that explain how to proceed without blaming the user.”

For a user happily planning to go for a walk, the server may generate:
“You are a friendly conversation AI that speaks a regional dialect. The user happily said: ‘The weather is nice today, so I'm goin for a walk’. Generate exactly one sentence in natural regional dialect that shows empathy and encourages the user to enjoy their walk.”

The server logs each prompt sentence, along with input conditions and model outputs, as part of a dialogue history. This explicit prompt structure is crucial because it makes the generative AI model's behavior reproducible and testable, and allows systematic variation of conditions (dialect, emotional target, style) without changing the underlying model weights.

The server implements the response generation unit by calling a generative AI model through a machine learning framework or an external service. In one embodiment, the generative AI model is a transformer-based language model with multiple self-attention layers and feed-forward sublayers. The server tokenizes the prompt sentence using a predefined vocabulary, converts tokens to embeddings, and feeds them into the generative model. The model computes a sequence of hidden states through stacked attention layers and outputs a probability distribution over the vocabulary for each time step.

The server performs controlled decoding by applying methods such as top-k sampling, nucleus sampling, or beam search, configured to match the required style and length. For example, the server constrains generation to one or two sentences and stops generation when a sentence boundary token is produced. The server may also impose lexical constraints derived from the dialect lexicon to prefer regionally appropriate expressions. This combination of prompt design and constrained decoding enables the server to control content and style more precisely than a simple template system would.

The server implements the response verification unit as a pipeline of rule-based filters and, optionally, a secondary classification model. The server examines the generated response sentence for forbidden terms, policy-violating phrases, or disallowed topics using pattern matching rules. The server may also use a small classifier to rate coherence with the user's intent and emotion. When the response fails verification, the server either modifies the prompt sentence (for example, by adding an explicit prohibition) and re-invokes the generative AI model, or discards the response and falls back to a safe default message. This additional verification layer reduces the risk of inappropriate or confusing responses, and thus contributes to reliability of the system.

The server implements the output control unit to manage how responses are sent to and presented on the terminals. The server encapsulates the selected response sentence, optional standard-language translation, and recommended speech synthesis parameters (speaking rate, pitch, voice type) into a structured message, for example a JSON object. The server selects slower speaking rates and higher-contrast display parameters when metadata indicates that the user is an elderly person. By dynamically adapting output parameters, the server improves intelligibility and reduces user cognitive load. This integration of content generation with device-level output settings provides a technical effect that goes beyond mere text generation.

The server implements the learning data management unit using a database schema that associates audio file paths, first text sequences (dialect), second text sequences (standard), emotional state labels, prompt sentences, generative responses, and dialogue identifiers. The server stores these elements as normalized records and maintains indexes on key fields such as dialect type, emotion label, and scenario identifier. This design allows efficient sampling of training data subsets tailored to specific dialects or emotional categories. It also supports reproducible audits of model behavior, because each response can be traced back to its prompt and input conditions.

The server implements the model learning unit to perform periodic or continuous training and fine-tuning of the speech recognition model and the emotion estimation model. The server retrieves batches of training data from the learning data management unit, converts text sequences into token indices, and loads corresponding acoustic features from storage. The server computes model outputs, evaluates loss functions (for example, connectionist temporal classification loss for speech recognition and cross-entropy loss for emotion classification), and performs weight updates using a gradient-based optimizer.

The server may augment training data using pseudo data generated by the generative AI model. For instance, the server constructs prompt sentences that request new dialect sentences in specific emotional tones, obtains generated text, and uses a text-to-speech system to synthesize corresponding audio waveforms. The server then adds these synthetic audio-text-emotion triples to the training set. This data augmentation procedure populates low-resource dialects and rare emotional categories with additional examples, thereby reducing class imbalance and improving generalization. Because the synthetic data follows explicit templates and controlled prompt conditions, it introduces variations that are difficult for human data collectors to produce consistently.

The terminal implements the client application to coordinate audio capture and response presentation. The terminal reacts to user input events, such as tapping a “start recording” button, by initializing a recording session with the platform's audio API, setting parameters like sampling rate and bit depth. The terminal records microphone input into a memory buffer, optionally displays recording status, and upon completion encodes the buffer using a general-purpose codec library. The terminal creates metadata describing the recording context and sends both audio and metadata to the server via an encrypted communication protocol. By performing compression on-device, the terminal reduces network bandwidth consumption and decreases end-to-end latency, which is particularly beneficial in constrained or wireless network environments.

The terminal receives response messages from the server, parses the structured data, and updates the user interface. The terminal displays the dialect response text, optionally with a standard-language translation, and configures the text-to-speech engine with the parameters supplied by the server. The terminal then synthesizes and plays back the speech. This interaction closes the loop between server-side processing and user experience, and ties the abstract linguistic and emotional computations to concrete control of audio and display hardware.

This overall system realizes more than an abstract sequence of information processing steps. The server and terminal cooperate to implement a feedback loop in which dialect-aware and emotion-aware models directly control hardware-level behaviors (microphone capture, codec selection, screen display properties, and speech synthesis characteristics). The specific data structures (dialect-aware feature tensors, dialect/standard text pairs, prompt templates, dialogue logs) and algorithms (dialect-embedded neural networks, explicit prompt sentence construction, constrained decoding, verified response selection, and synthetic data generation) improve the technical performance of the computing system itself. As a result, the server can recognize dialectal speech with higher accuracy, estimate emotion more reliably, generate contextually appropriate dialect responses, reduce average response time through efficient batching and normalization, and continuously refine models using structured training data not practically creatable by human operators alone.

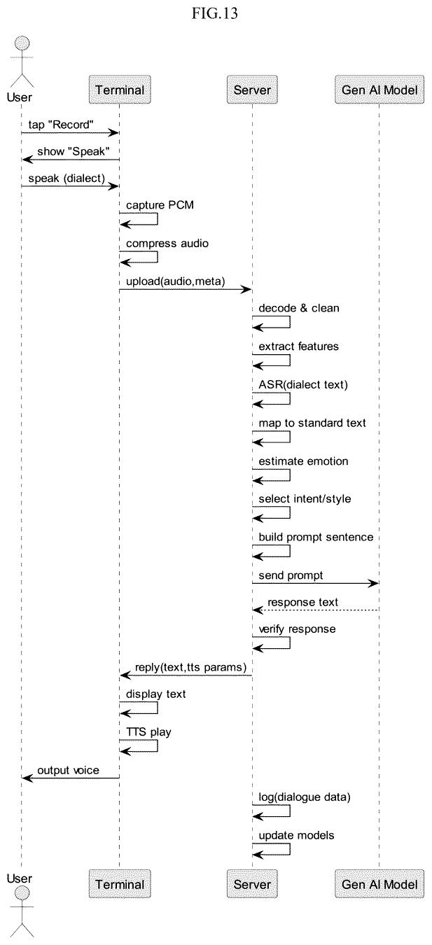

The following describes the processing flow using FIG. 13.

### Step 1:

The terminal initializes recording conditions.

The terminal receives a user operation input, such as a tap on a “Start recording” button, as input. The terminal uses a platform audio API to allocate an audio buffer in memory and to set recording parameters including sampling rate, quantization bit depth, channel count, and maximum recording duration. The terminal performs parameter setting as a data operation on internal configuration structures and updates a recording state flag from “idle” to “ready.” The terminal outputs an initialized audio capture context and a UI update that displays a microphone icon and a message such as “Recording will start. Please speak in your dialect.”

### Step 2:

The user provides dialect speech.

The user receives the visual cue from the terminal display as input. The user holds the terminal at an appropriate distance and utters a sentence in a dialect, for example, “The weather is nice today, so I'm goin for a walk” or “I'm goin to the hospital tomorrow and I'm a little scared.” The user produces an analog acoustic pressure waveform as output, which is captured by the terminal's microphone and forwarded to the terminal audio stack.

### Step 3:

The terminal acquires and buffers raw audio samples.

The terminal takes the analog microphone signal as input through the audio API. The terminal performs analog-to-digital conversion (by hardware/OS) and obtains a stream of PCM samples, which the terminal appends to a circular or dynamically growing buffer in RAM. The terminal performs data operations that include incrementing a write index, updating a recorded duration counter, and checking whether a maximum duration threshold is exceeded. The terminal outputs a buffered sequence of PCM samples (for example, 16 kHz, 16-bit mono) and a recording state update that changes to “recording.” The terminal also outputs a UI indication, such as a red “Recording . . . ” banner.

### Step 4:

The terminal finalizes and compresses the audio data.

The terminal receives a stop trigger as input, either from a user tap on a “Stop” button or from a timer that reaches the maximum duration. The terminal calls the audio API to stop the recording session and performs a data operation of writing the PCM buffer to a temporary file in a standard uncompressed format. The terminal then invokes an audio codec library to read the PCM file and apply a compression algorithm (for example, lossless or low-bitrate encoding), converting the raw samples into a compressed bitstream. The terminal deletes or releases the intermediate PCM buffer and file to free memory. The terminal outputs a compressed audio file path and size, which are used as payload for upload.

### Step 5:

The terminal constructs metadata and an upload request.

The terminal takes as input the compressed audio file path and internal context data including user ID, dialect ID, scenario ID, device type, OS version, and timestamp. The terminal performs data processing by serializing these context values into a structured metadata object (for example, a JSON-form string), and by constructing an HTTP request body in multipart form-data format. The terminal attaches the audio file as a binary part and the metadata as a text part. The terminal then calls a network library to open an HTTPS connection to a server endpoint, applying an encrypted communication protocol. The terminal outputs a transmitted network request and a UI progress indicator such as “Uploading your voice to the server . . . ”

### Step 6:

The server receives and stores the audio and metadata.

The server takes the HTTPS request as input via a network interface and a web framework. The server parses HTTP headers and the multipart body, separating the audio binary part from the textual metadata. The server performs data processing by generating a unique file name, writing the audio bytes to a persistent storage device, and decoding the metadata string into structured fields. The server inserts a new record into a database table with attributes such as user ID, dialect ID, scenario ID, audio file path, upload time, and processing status. The server outputs a stored audio file on disk and a persistent database record ID, and returns an acknowledgment response to the terminal.

### Step 7:

The server decodes and cleans the audio waveform.

The server takes as input the audio file path and associated metadata retrieved from the database. The server calls an audio I/O library to decode the compressed audio into a time-domain waveform sampled at a predetermined rate, producing a numeric array (for example, a floating-point array). The server performs signal processing operations including pre-emphasis filtering, DC offset removal, noise suppression using spectral subtraction or a pre-trained denoising network, and dereverberation using learned or analytical filters. The server also computes frame energy and removes leading and trailing frames with energy below a threshold to trim silences. The server outputs a cleaned waveform array and diagnostic information about signal quality, such as noise level indicators.

### Step 8:

The server extracts acoustic feature tensors.

The server takes the cleaned waveform as input. The server applies frame segmentation with a sliding window and a window function, then computes a short-time Fourier transform and maps spectral magnitudes to a mel filterbank. The server performs data transformations to derive mel-spectrograms, cepstral coefficients, fundamental frequency tracks, energy contours, and auxiliary prosodic features such as speech rate and pause duration. The server normalizes these features using dialect-specific normalization parameters read from the database (for example, mean and variance of F0 for a dialect). The server stacks the features into a tensor of shape [time, feature_dimension], converts it to the appropriate numerical type for a machine learning framework, and transfers the tensor to a GPU device. The server outputs a GPU-resident acoustic feature tensor and associated dialect embedding indices.

### Step 9:

The server performs dialect-aware speech recognition.

The server takes the acoustic feature tensor and a dialect ID as input. The server looks up a dialect embedding vector from an embedding matrix and combines it with the acoustic features, such as by adding or concatenating the embedding to each time frame. The server performs a forward pass through a neural speech recognition model implemented in a deep learning framework, computing hidden states and token probability distributions over a vocabulary for each time step. The server then runs a beam search decoder that evaluates multiple candidate token sequences, using accumulated log probabilities and optional language model scores as a scoring function. The server outputs a first text sequence that contains dialect expressions, for example, a transcription like “I'm goin to the hospital tomorrow and I'm a little scared,” and a decoding score associated with this sequence.

### Step 10:

The server converts dialect expressions to standard language.

The server takes the first text sequence and a dialect lexicon stored in the database as input. The server tokenizes the first text sequence into tokens, then iterates over the tokens and queries the lexicon to find standard-language equivalents for recognized dialect tokens. When multiple candidates exist, the server evaluates short candidate sequences with a probabilistic language model to select a likely mapping. The server replaces dialect tokens with chosen standard tokens and reconstructs a second text sequence in the standard language. The server outputs this second text sequence and also outputs a mapping table that links each dialect token to its standard counterpart for later use in learning.

### Step 11:

The server estimates the user's emotional state.

The server takes as input the acoustic feature tensor, the dialect information (such as dialect ID and detected dialect tokens), and optionally features derived from the second text sequence. The server feeds the acoustic feature tensor into an emotion estimation network, which computes a sequence of hidden features and then applies pooling (for example, attention pooling or mean pooling) to form an utterance-level vector. The server concatenates this vector with a dialect embedding vector and passes the result through fully connected layers with nonlinear activations and a final output layer. The server computes probabilities over emotion categories or continuous emotion scores, and selects the most probable category as the emotional state. The server outputs an emotion label (for example, “anxiety,” “calm,” or “joy”) and associated confidence scores.

### Step 12:

The server derives dialogue intent and response style.

The server takes the second text sequence and the emotional state as input. The server uses either a small intent classifier model or rule-based keyword detection to infer an intent, such as “ask for explanation,” “express worry,” or “casual greeting.” Based on the combination of intent, emotional state, and dialect type, the server consults a policy table that defines response styles, such as “reassuring and concise” or “polite two-sentence explanation.” The server outputs a response style descriptor containing fields like target dialect, number of sentences, politeness level, and emotional target for the reply.

### Step 13:

The server constructs a prompt sentence for the generative AI model.

The server takes as input the first text sequence, the second text sequence, the emotional state, the response style descriptor, the dialect type, and dialogue history information. The server selects a natural-language prompt template from a library, using conditions such as intent, emotion, and dialect. The server performs data insertion by filling template placeholders with the dialect text, the standard text, and emotional descriptors. For example, the server generates a prompt sentence such as:
“You are a gentle support AI that speaks a regional dialect. The user, sounding a bit anxious, said: ‘I'm goin to the hospital tomorrow and I'm a little scared’. Generate exactly one short sentence in natural regional dialect that reassures the user and makes them feel more at ease.”

The server outputs this fully instantiated prompt sentence and records it in a dialogue log with a conversation identifier.

### Step 14:

The server generates a response sentence with the generative AI model.

The server takes the prompt sentence as input. The server tokenizes the prompt using the generative model's tokenizer and converts tokens to numerical IDs. The server submits the token sequence to a transformer-based generative AI model running on a processor or a dedicated accelerator, and obtains output probability distributions for successive tokens. The server applies a decoding strategy such as top-k sampling with a temperature parameter or beam search limited by a maximum token count. The server converts the selected token sequence back into text, yielding a response sentence in the specified dialect. The server outputs this response sentence as candidate text for user presentation.

### Step 15:

The server verifies and selects the generated response.

The server takes the candidate response sentence as input. The server applies rule-based filters that check for forbidden terms, length violations, or missing emotional cues, and optionally passes the sentence through a lightweight classifier to assess coherence with the intent and emotion. If the sentence fails verification, the server marks it as rejected and may adjust the prompt or decoding parameters and re-generate another candidate. The server outputs a verified response sentence that satisfies policy constraints, and logs both the accepted sentence and any rejected candidates for later analysis.

### Step 16:

The server prepares the response message for the terminal.

The server takes the verified response sentence, the emotional state, and presentation preferences as input. The server constructs a structured message object containing the response text in dialect, an optional standard-language translation derived from the second text sequence, and recommended text-to-speech parameters such as speaking rate, pitch, and voice style. The server may set slow speech rate and high contrast flags when metadata indicates an elderly user. The server outputs this message object as a serialized response payload and sends it via HTTPS to the terminal.

### Step 17:

The terminal presents the response to the user.

The terminal takes the response payload as input from the server. The terminal parses the structured data to extract the dialect response text, optional standard-language text, and TTS parameters. The terminal updates the display to show the dialect text in a larger, high-contrast font and, if provided, the standard text in a smaller font below it. The terminal then calls a text-to-speech API with the response text and configures the engine with the provided rate and pitch. The terminal generates synthesized audio samples and plays them through the speaker. The terminal outputs visible and audible feedback to the user and resets its UI to allow the user to start a new utterance.

### Step 18:

The server stores dialogue data for learning.

The server receives as input the audio file path, the first and second text sequences, the emotional state, the prompt sentence, and the final response sentence, together with dialogue identifiers. The server performs a data operation by inserting a record into the learning data management database that links these items as a single training example. The server creates indexes on fields such as dialect type and emotion label, enabling efficient retrieval for later training. The server outputs updated database contents that now include this dialogue turn as potential training data.

### Step 19:

The server updates models using collected and synthetic data.

The server takes as input batches of stored dialogue records retrieved according to specified criteria (for example, a given dialect or emotion). The server loads associated acoustic features and text sequences and feeds them into the speech recognition model and emotion estimation model in training mode. The server computes loss values such as CTC loss for recognition and cross-entropy loss for emotion classification, performs backpropagation to obtain gradients, and updates model parameters using an optimizer. The server may also generate pseudo data by constructing special prompt sentences that instruct the generative AI model to produce new dialect sentences with specified emotions, synthesizing corresponding audio, and adding these to the training set. The server outputs updated model parameter sets that improve accuracy on dialect speech and emotion estimation, and records training metadata such as epoch count and validation metrics.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional speech-based human-machine interfaces in caregiving environments suffer from several technical limitations that degrade system performance at the level of core computer technology. First, automatic speech recognition engines are typically optimized for a standard language and are not robust to regional dialects, non-standard vocabulary, or pronunciation variability common among elderly users. As a consequence, the underlying speech-processing pipeline produces erroneous text outputs and high recognition error rates when confronted with dialectal speech, which in turn propagates downstream and causes incorrect command interpretation and unstable system behavior.

Second, conventional systems generally process speech and text independently of user emotion. Acoustic and textual signals are fed to models that treat all utterances as semantically equivalent, regardless of whether a user is calm, anxious, angry, or lonely. This lack of integrated emotion awareness leads to response-generation modules and control logic that cannot adapt system behavior to the user's psychological state. From a computing standpoint, the system fails to fuse multimodal information (audio features and textual features) into a unified representation, resulting in suboptimal decision-making and rigid control strategies.

Third, typical architectures employ static models that are trained offline and deployed without continuous adaptation. These models do not leverage the large volume of interaction data generated during real-world operation to improve recognition accuracy, dialect coverage, or emotion sensitivity. The lack of an in-situ learning loop prevents the system from evolving its internal parameters over time and from expanding support to new dialects in a scalable manner. As a result, recognition accuracy and response quality remain constrained, particularly in heterogeneous user populations.

Fourth, existing pipelines often treat speech recognition, natural language generation, and device control as loosely coupled components. They do not exploit generative AI models with structured prompt sentences as a central mechanism for dialect-to-standard conversion, emotion-aware response generation, and data augmentation. This separation leads to fragmented processing, multiple hand-crafted rules, and increased engineering complexity. The computing infrastructure is thus burdened with numerous ad hoc modules, leading to higher latency, increased error propagation, and difficulty in maintaining consistency across components.

Fifth, many systems focus only on high-level application outcomes (for example, “bring tea” or “turn on television”) and do not explicitly optimize lower-level computational processes such as feature extraction, model inference orchestration, and integrated state estimation. There is no cohesive mechanism to jointly manage acoustic preprocessing, multimodal emotion inference, generative-model prompting, and planning of control commands within a single, processor-centric architecture. Consequently, the overall computing system exhibits inefficient resource usage, higher processing delays, and decreased robustness to noisy input and dialectal variation.

Accordingly, there is a need for a technical solution that improves the operation of computer systems used in caregiving dialog interfaces by: (i) enabling accurate recognition and interpretation of dialectal speech, (ii) integrating acoustic and textual emotion recognition into a unified emotional state representation, (iii) harnessing generative AI models and structured prompt sentences to perform both language conversion and emotion-aware response generation, (iv) automatically generating and incorporating synthetic dialect data to expand model coverage, and (v) continuously updating internal model parameters using real interaction data. Such a solution should provide a processor-level architecture that more efficiently orchestrates speech preprocessing, multimodal inference, generative modeling, and control command generation, thereby improving the functioning and reliability of the underlying computer technology itself.

The specific processing by the specific processing unit 290 of the data processing device 12 in Application Example 2 is realized by the following means.

The present invention provides a server comprising a processor configured to acquire speech information from an information processing terminal that collects utterances of a user, perform, by executing an audio preprocessing program, noise suppression, reverberation suppression, echo cancellation, volume normalization, spatial directivity control, and voice activity detection on the acquired speech information to generate preprocessed speech information, extract acoustic feature information from the preprocessed speech information, and input the acoustic feature information to a speech recognition model to generate dialect-containing character information representing a transcription of the user's utterance in a dialect; construct a first prompt sentence for a generative AI model by concatenating a character string including the dialect-containing character information with an instruction sentence requesting conversion to standard-language text, input the first prompt sentence to the generative AI model, and cause the generative AI model to autoregressively output standard-language text data corresponding to the dialect-containing character information; estimate a first emotional state of the user by inputting the acoustic feature information to a first emotion recognition model configured to output an emotion category and an emotion intensity based on acoustic characteristics; estimate a second emotional state of the user by inputting at least one of the dialect-containing character information and the standard-language text data to a second emotion recognition model or to the generative AI model using a second prompt sentence requesting an emotion label and an intensity, and obtain an emotion category and an emotion intensity based on textual characteristics; integrate an estimation result of the first emotion recognition model and an estimation result of the second emotion recognition model or the generative AI model to calculate integrated emotional information including at least an emotion category, an emotion intensity, and an urgency index, the integration being performed by a weighted combination or a meta-classification process executed by the processor; generate, based on the standard-language text data and the integrated emotional information, a third prompt sentence including conditions describing at least a response policy, a speaker attribute, and an output style, input the third prompt sentence to the generative AI model, and cause the generative AI model to generate response character information to the user; and generate, based on the response character information and the integrated emotional information, control command information including at least a destination position, a travel route, a travel speed, an operation type, audio output content, and display output content for a caregiving support apparatus, and transmit the control command information and the response character information to the information processing terminal for execution of speech synthesis and device control. This enables an integrated computer-implemented pipeline in which the processor centrally orchestrates acoustic preprocessing, dialect-aware speech recognition, multimodal emotion inference, prompt-based generative modeling, and generation of device control commands, thereby improving recognition accuracy for dialectal speech, enhancing robustness and responsiveness of the system to user emotions, reducing processing latency and error propagation across components, and allowing the computing system to operate more effectively and efficiently in real-world caregiving dialog environments.

The term “speech information” refers to digital data representing an acoustic signal of a user's utterance, obtained by converting an analog sound wave captured by an acoustic input device into a sampled and quantized waveform or encoded audio stream.

The term “information processing terminal” refers to an electronic apparatus equipped with at least an acoustic input device, an acoustic output device, a communication interface, and a control processor, the electronic apparatus being configured to capture speech information from a user, transmit the speech information to a server, and execute control of a caregiving support apparatus based on control command information.

The term “noise suppression” refers to a signal processing operation performed on speech information to attenuate or remove unwanted background components such as stationary noise, environmental noise, or device-generated noise, while preserving components related to the user's voice.

The term “reverberation suppression” refers to a signal processing operation that reduces the effect of reflections and late reverberations in an acoustic environment, thereby shortening the effective reverberation time and making speech components more distinct for subsequent analysis.

The term “echo cancellation” refers to a signal processing operation that removes acoustic echoes caused by playback of audio from an acoustic output device being re-captured by an acoustic input device, using reference signals corresponding to the playback audio.

The term “volume normalization” refers to a signal processing operation that adjusts the amplitude or power level of speech information so that the overall loudness is brought into a predetermined range suitable for feature extraction and model inference.

The term “spatial directivity control” refers to a beamforming or related spatial filtering operation applied to multichannel acoustic signals to emphasize sound arriving from a desired direction, such as the direction of the user, and to suppress sound arriving from other directions.

The term “voice activity detection” refers to a process that analyzes speech information to determine time intervals in which a user is speaking and to segment a continuous acoustic signal into one or more voice sections corresponding to utterances.

The term “preprocessed speech information” refers to speech information that has undergone at least one of noise suppression, reverberation suppression, echo cancellation, volume normalization, spatial directivity control, and voice activity detection so as to be suitable for feature extraction and subsequent model processing.

The term “acoustic feature information” refers to numerical representations derived from preprocessed speech information, including but not limited to spectrograms, filterbank energies, cepstral coefficients, fundamental frequency contours, energy trajectories, and other time-frequency or statistical descriptors used as input to machine learning models.

The term “speech recognition model” refers to a machine learning model, implemented for example as a neural network, that receives acoustic feature information as input and outputs a sequence of tokens or characters corresponding to a transcription of a user's utterance.

The term “dialect-containing character information” refers to text data produced by the speech recognition model that represents a user's utterance and includes linguistic features characteristic of a regional or non-standard dialect, such as dialect-specific vocabulary, expressions, or inflections.

The term “standard-language text data” refers to text data representing the semantic content of a user's utterance in a standardized or commonly understood language form, generated from dialect-containing character information by a conversion process using a generative AI model.

The term “generative AI model” refers to a machine learning model, typically a neural network-based language model, configured to generate text data in an autoregressive or otherwise generative manner in response to input text, including prompt sentences that specify desired tasks, styles, or constraints.

The term “prompt sentence” refers to a text sequence that includes at least one instruction, condition, or example, the text sequence being provided as input to a generative AI model to specify a desired output operation such as dialect-to-standard conversion, emotion estimation, or response generation.

The term “first prompt sentence” refers to a prompt sentence that includes dialect-containing character information and an instruction to convert the dialect-containing character information into standard-language text data.

The term “second prompt sentence” refers to a prompt sentence that includes at least one of dialect-containing character information and standard-language text data and specifies an instruction for estimating an emotional state of a user, including at least an emotion category and an emotion intensity.

The term “third prompt sentence” refers to a prompt sentence that includes at least standard-language text data and integrated emotional information and describes conditions for generating a response to a user, including a response policy, a speaker attribute, and an output style.

The term “first emotion recognition model” refers to a machine learning model that receives acoustic feature information as input and outputs a first estimation of an emotional state of a user based on acoustic characteristics of the user's voice.

The term “second emotion recognition model” refers to a machine learning model that receives at least one of dialect-containing character information and standard-language text data as input and outputs a second estimation of an emotional state of a user based on linguistic and contextual characteristics of the text.

The term “emotional state” refers to information representing a psychological or affective condition of a user, including at least one emotion category such as joy, anger, anxiety, sadness, neutrality, or loneliness, and optionally including an intensity value representing the strength of the emotion.

The term “integrated emotional information” refers to information derived by combining a first estimation result of the first emotion recognition model and a second estimation result of the second emotion recognition model or the generative AI model, the information including at least an emotion category, an emotion intensity, and optionally an urgency index.

The term “urgency index” refers to a numerical indicator derived from integrated emotional information and optionally from temporal changes thereof, the indicator representing a degree of urgency or priority with which a caregiving action should be taken.

The term “response policy” refers to a set of conditions or rules specifying how a system should respond linguistically or behaviorally to a user, based on at least the user's intent and emotional state, such as whether to reassure, apologize, encourage, or provide detailed explanation.

The term “speaker attribute” refers to information indicating characteristics of a user or a system voice, including but not limited to age group, politeness level, role, or relationship, used to adjust the style of generated responses.

The term “output style” refers to a specification of linguistic and formatting characteristics of a generated response, including at least politeness level, sentence length, formality, and presence or absence of certain expressions.

The term “response character information” refers to text data generated by the generative AI model in accordance with a prompt sentence and integrated emotional information, the text data representing a response message to be presented to the user by speech synthesis or display.

The term “control command information” refers to structured data including parameters for controlling a caregiving support apparatus or an information processing terminal, the parameters including at least a destination position, a travel route, a travel speed, an operation type, audio output content, and display output content.

The term “destination position” refers to a location in a physical or virtual space, specified by coordinates, identifiers, or similar parameters, that a caregiving support apparatus is instructed to reach.

The term “travel route” refers to a sequence of positions, waypoints, or path segments along which a caregiving support apparatus is instructed to move in order to reach a destination position.

The term “travel speed” refers to a parameter specifying a velocity or speed profile to be used by a caregiving support apparatus when moving along a travel route.

The term “operation type” refers to a category of action to be performed by a caregiving support apparatus, including but not limited to movement, object manipulation, status notification, or interaction with a user.

The term “audio output content” refers to information specifying speech or sound that is to be output by an acoustic output device, typically derived from response character information.

The term “display output content” refers to information specifying visual elements, including text, icons, or images, that are to be presented on a display device.

The term “caregiving support apparatus” refers to a machine that performs at least one support action in a caregiving environment, the machine including at least one of a movement mechanism, a work mechanism, an acoustic input device, an acoustic output device, and a display device, and being controllable by control command information.

The term “learning information” refers to a collection of data stored for use in training, retraining, or fine-tuning machine learning models, the data including at least speech information, dialect-containing character information, standard-language text data, integrated emotional information, and response character information.

The term “machine learning process” refers to a computational procedure executed by a processor to adjust parameters of a machine learning model using learning information, including at least one of supervised learning, semi-supervised learning, unsupervised learning, and fine-tuning based on optimization algorithms.

The term “candidate dialect expressions” refers to multiple text variants generated by a generative AI model that represent alternative ways of expressing a given standard-language text in one or more dialects.

The term “additional learning information” refers to learning information that is newly added to an existing training dataset, including at least candidate dialect expressions and their associations with standard-language text data, used to improve or expand the capabilities of a speech recognition model or an emotion recognition model.

The term “retraining or fine-tuning” refers to a process in which parameters of an already trained machine learning model are further adjusted using additional learning information, in order to improve model performance or adapt the model to new data distributions.

In the following embodiments, the term “server” denotes a computing apparatus that includes at least one central processing unit (CPU), at least one graphics processing unit (GPU) configured for general-purpose parallel computation, a main memory, a nonvolatile storage device, and a network interface, operating under a server-class operating system such as a general-purpose UNIX-like operating system. The term “terminal” denotes an information processing apparatus installed in proximity to a user, and the term “user” denotes a care receiver such as an elderly person who interacts with the system in a caregiving environment.

Server executes various software components including an audio preprocessing module, a feature extraction module, a speech recognition module, a generative AI model inference module, an emotion recognition module, a prompt sentence construction module, a control command generation module, and a learning module. Server implements these modules using a machine learning framework such as a general-purpose tensor computation library and a neural network library. Server stores trained parameters of models in a nonvolatile storage device such as a solid-state drive, and loads the parameters into main memory and GPU memory during inference and training.

Terminal includes at least one acoustic input device such as a microphone array, at least one acoustic output device such as a loudspeaker, a display device, a local processor such as a system-on-chip, and a network interface supporting a wired or wireless communication protocol. Terminal optionally includes one or more actuators such as wheel motors, joint motors, or other mechanisms forming a caregiving support apparatus. Terminal executes an embedded operating system and local software components including audio input drivers, local audio preprocessing modules, a communication client, a speech synthesis engine, and robotic control middleware such as a general-purpose robot operating framework.

User produces speech by speaking toward terminal in natural language, including regional dialect expressions. The acoustic waveform propagates in air and is captured by a microphone array of terminal. Terminal samples the analog signals using an analog-to-digital converter at a predetermined sampling frequency, such as 16 kHz, and a predetermined quantization resolution, such as 16 bits per sample, thereby generating multi-channel pulse-code modulated data. Terminal buffers this multi-channel data in main memory and passes it to its local audio preprocessing module.

Terminal executes local audio preprocessing using a real-time audio library such as a general-purpose audio processing library. Terminal applies echo cancellation by using as reference a copy of any audio already sent to the loudspeaker; the echo canceller uses an adaptive filter to estimate and subtract the echo path response. Terminal executes noise suppression using a spectral subtraction or statistical model-based algorithm implemented in the library, thereby attenuating stationary background noise. Terminal performs beamforming by applying a delay-and-sum or minimum variance distortionless response algorithm to multi-channel data in the frequency domain, steering a spatial beam toward a direction corresponding to the user's estimated position. Through these operations, terminal generates a single-channel or reduced-channel preprocessed waveform in which speech components from the user are enhanced and noises are reduced. This reduction of interference significantly improves the signal-to-noise ratio supplied to server and, as a result, increases recognition accuracy and reduces computational load on subsequent models that no longer need to compensate for severe noise.

Terminal performs voice activity detection using an energy-based detector or a small neural network classifier to decide whether each frame belongs to speech or non-speech. Terminal segments the stream into utterance units and attaches metadata such as a user identifier, a terminal identifier, and start and end timestamps for each utterance. Terminal optionally applies a perceptual audio codec such as a variable bit rate codec to compress the utterance segments, thereby reducing payload size. By performing segmentation and compression on terminal side, the system reduces network bandwidth usage and server-side buffering requirements, which in turn shortens end-to-end latency and allows the system to scale to a larger number of terminals.

Terminal encapsulates compressed audio data and metadata into a message structure and transmits the message to server over a secure channel such as a transport layer security-based protocol. The encryption ensures confidentiality, while the segmentation and metadata structure ensure that server can process each utterance independently without complex stream reconstruction.

Server receives messages using web server software and application server software. Server extracts metadata fields and stores them in a message queue or short-term storage. Server passes the compressed audio payload to an audio decoding library, which reconstructs single-channel pulse-code modulated data. Server then executes additional audio preprocessing, such as peak normalization and optional spectral denoising, using a general-purpose signal processing library. Server computes acoustic feature information such as log-Mel filterbank features or Mel-frequency cepstral coefficients using sliding windows. Server stores the resulting feature tensor, which may have a shape such as (time frames, frequency bins), as a multi-dimensional array of floating-point numbers in main memory or GPU memory.

Server performs automatic speech recognition by inputting the acoustic feature tensor into a neural speech recognition model. In one embodiment, server employs a sequence-to-sequence neural architecture such as a Conformer, Transformer, or connectionist temporal classification-based model. The model consists of an input projection layer, multiple encoder blocks with self-attention and convolutional sublayers, and an output layer producing distributions over tokens representing characters or subword units. Server uses a decoding algorithm such as beam search to determine the token sequence with the highest probability under the model. Server converts the token sequence into a Unicode string, which comprises dialect-containing character information. Because the feature extraction and model architecture are optimized to handle long-range dependencies and varied prosody, the system attains higher recognition accuracy for dialectal and elderly speech than conventional hidden Markov model-based or short-window models.

Server constructs a prompt sentence for dialect-to-standard conversion by a deterministic string concatenation procedure. Server generates an instruction portion and inserts the recognized dialect-containing character information into a designated position. For example, in one embodiment, server composes the following text:
“Please convert the following dialect sentence into polite standard Japanese without changing its meaning.
Dialect: ‘Bring me some tea’
Standard Japanese:”

Server passes this prompt sentence to a tokenizer corresponding to a generative AI model, such as a subword segmentation algorithm. Server obtains a token sequence and input embeddings, and then applies a generative AI model that comprises multiple stacked Transformer decoder layers with self-attention and feed-forward sublayers. Server performs autoregressive decoding, at each time step computing a probability distribution over the vocabulary conditioned on previously generated tokens and the prompt. Server may apply constraints such as a maximum output length or low temperature sampling to ensure concise and controlled output. Server then converts the generated tokens into a text string and extracts the standard-language text data, such as “Please bring me some tea”.

By using a single generative AI model and structured prompt sentences instead of multiple hand-crafted rules or separate translation tables, server simplifies the architecture while enabling flexible adaptation to new dialects. The combination of prompt design and model architecture allows the system to consistently map extremely varied dialect expressions to standardized output without requiring the explicit programming of grammar rules, thereby reducing the engineering burden and improving adaptability.

Server concurrently or subsequently performs emotion recognition based on both acoustic and textual information. Server inputs the acoustic feature information or additional derived features such as fundamental frequency contours, energy trajectories, and speaking rate into a first emotion recognition model. In one embodiment, this model is a bi-directional recurrent neural network with attention, or a Transformer-based classifier, that outputs a vector of scores over emotion categories and intensities. The training of this model uses a supervised learning procedure: server minimizes a loss function, such as cross-entropy combined with mean squared error for intensity prediction, by gradient descent using labeled training data. As a result, the model learns mapping from patterns of pitch variation, intensity, and temporal dynamics to emotional states such as anger, anxiety, sadness, and neutrality. Server also estimates emotion from text using either a text classification model or the generative AI model with a dedicated prompt sentence. In one embodiment, server constructs a prompt sentence such as:
“Please estimate the speaker's emotional state for the following utterance. Emotion categories: joy, anger, anxiety, sadness, or neutral. Also output the intensity (0-1).
Utterance: ‘Bring me some tea’
Output format:
Emotion category:
Intensity:”

Server inputs this prompt sentence to the same generative AI model and parses the output to extract an emotion category and an intensity value. In another embodiment, server uses a transformer-based encoder model pre-trained on large-scale text, adds a classification head, and fine-tunes the model on emotion-labeled data. In either case, server obtains a text-based emotion estimate that reflects lexical choices, syntactic structure, and context, which are different feature modalities from acoustic cues. This dual-modality approach improves robustness because the system can still infer emotional state even when acoustic cues are weak or when text includes emotion markers not obvious from prosody.

Server integrates the acoustic-based and text-based emotion estimates by mapping them into a shared emotion vector space. Server assigns weight parameters to each modality and computes a weighted sum of scores. In a more advanced embodiment, server uses a meta-classifier that takes as input both modality score vectors and outputs integrated emotional information. The meta-classifier may be a shallow feed-forward network trained to minimize discrepancy with ground truth integrated labels. Server may also maintain a short time window of integrated emotional information vectors for each user and compute temporal statistics such as moving averages or trend indicators, thereby deriving an urgency index. For example, if anxiety scores remain high over several consecutive utterances, server sets a higher urgency index. This integrated and temporally-aware emotion representation enables server to adapt system behavior beyond simple one-shot emotion tags.

Server constructs a third prompt sentence for response generation using both the standard-language text data and the integrated emotional information. Server populates a template with fields of the original dialect expression, its standard-language interpretation, the estimated emotional state, and a response policy. For example, server may generate:
“You are a conversational agent for a caregiving robot.

Under the following conditions, generate one polite and reassuring response to an elderly user.
User utterance (dialect): ‘Bring me some tea’
Content in standard Japanese: ‘Please bring me some tea’
Estimated emotional state: neutral (intensity 0.6), loneliness (intensity 0.3)
Response policy: accept the request and provide reassurance.
Output:”

Server inputs this prompt to the generative AI model, which then generates response character information such as “Yes, I'll bring you some tea. I'll be there in a moment, so please wait just a moment.” Server optionally applies post-processing to enforce length and politeness constraints. Through this prompt-based control, server can dynamically adjust the style and content of responses without rewriting procedural logic, which is a technical improvement in the flexibility and maintainability of dialog systems.

Server generates control command information for terminal and any caregiving support apparatus based on response character information and integrated emotional information. Server accesses stored map data and device state information, for example via a robot control middleware, and computes a travel route and travel speed using a path planning algorithm such as graph search on a cost map. Server determines an operation type, such as moving to the kitchen, interacting with a user, or sending a notification. Server then constructs a structured control command that includes destination position coordinates, travel route as a sequence of waypoints, speed parameters, operation type codes, and associated output contents such as the response text for speech and display messages for a screen.

By directly linking dialog understanding and emotional state to physical control commands, the system is not limited to abstract information processing but leads to concrete device control: the caregiving support apparatus moves in the physical environment and performs actions such as bringing an object, operating devices, or calling human staff. This tight integration of multimodal inference and robotic control, implemented with specific algorithms and data structures, provides a technical effect that goes beyond human-level manual control because the system simultaneously optimizes language understanding, emotional adaptation, and motion planning in real time.

Terminal receives control command information from server, parses the structure using its local processor, and triggers local modules. Terminal passes response character information to a text-to-speech engine, which performs text normalization, grapheme-to-phoneme conversion, prosody prediction, and waveform generation. Terminal outputs the synthesized speech through its loudspeakers, enabling user to hear the response. Terminal also forwards motion and operation parameters to a robot control stack, which converts high-level waypoints and velocities into low-level motor commands using feedback control algorithms. Terminal updates its display to show text information or pictorial icons that match the response. Through this combined operation, terminal ensures that user experiences a coordinated multimodal response.

Server continuously collects data arising from these interactions, including speech information, dialect-containing character information, standard-language text data, integrated emotional information, commanded responses, and execution outcomes. Server stores this information in a training database with associated labels or pseudo-labels. Server periodically runs a learning process in which it samples data from this database and performs gradient-based training or fine-tuning for the speech recognition model, the generative AI model (for domain adaptation), and the emotion recognition models. Server may use optimization algorithms such as stochastic gradient descent with momentum or adaptive learning rate methods, and loss functions such as cross-entropy for recognition, Kullback-Leibler divergence for distribution alignment, and combined regression losses for emotion intensity. By leveraging real-world data from actual users, server reduces domain mismatch and increases accuracy over time.

Server can also use the generative AI model to produce candidate dialect expressions from standard-language text by constructing a prompt sentence such as:
“Please list three polite expressions in a regional dialect that mean ‘Please bring me some tea’.”

Server examines the generated candidate dialect expressions and associates them with the standard-language text data. Server then adds these pairs to the training corpus for the speech recognition and emotion recognition models as additional learning information. Because the generative AI model can produce dialectal variations that may be rare or undersampled in collected corpora, this synthetic data augmentation improves the models' coverage of dialectal phenomena without manual collection. The training loop thereby exploits the generative AI model as a data generator in a non-conventional way, which is a technical tool for expanding model capability rather than a mere content generator.

In alternative embodiments, server may use different neural architectures, such as convolutional recurrent networks for acoustic modeling or encoder-decoder models with attention for speech recognition, and may switch between classifier-based and generative-model-based emotion estimation according to computational constraints. Server may also adjust prompt sentence formats or languages to support other language pairs or dialects. Terminal may be realized as a stationary kiosk, a mobile robot, or a wearable device, and the caregiving support apparatus may include various actuators or external controlled devices such as lighting or entertainment equipment.

The system provides several technical effects. By performing substantial preprocessing on terminal and feature extraction on server, the pipeline reduces the effective dimension and noise content of data before it enters large models, improving both computational efficiency and inference accuracy. By integrating acoustic and textual emotion recognition and combining their outputs algorithmically, the system enhances robustness against noisy conditions and incomplete cues. By using structured prompt sentences and a unified generative AI model for dialect conversion, emotion estimation, and response generation, the system reduces the number of separate models and rules, which reduces memory footprint and simplifies maintenance. By automatically generating and incorporating synthetic dialect data, the system improves the generalization of models to unseen dialects, reducing errors that would arise from data sparsity. By directly translating the integrated understanding of speech and emotion into structured control commands for physical devices, the system improves the functionality of the underlying computing and robotic platform, leading to faster, more accurate, and contextually appropriate actions than could be achieved by manual control or by simpler scripted dialog systems.

User benefits from this improved computing infrastructure by being able to speak naturally in dialect and receive prompt, emotionally appropriate responses and assistance from terminal and caregiving support apparatus. However, the essence of the invention resides in the specific configuration and cooperation of server, terminal, and neural models, and in the detailed data structures and algorithmic flows that yield technical improvements in recognition accuracy, processing speed, resource usage, and robustness of the overall computer-based system.

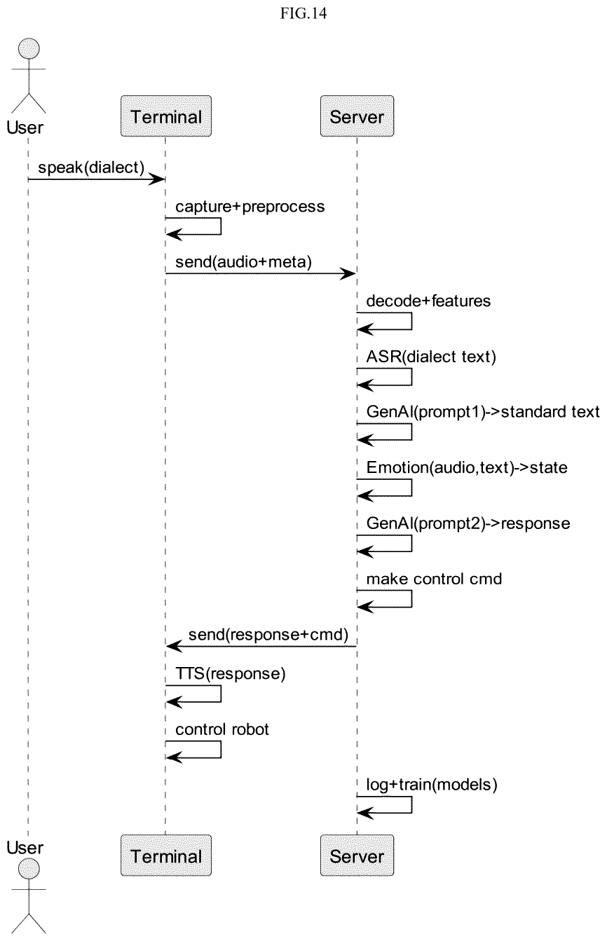

The following describes the processing flow using FIG. 14.

### Step 1:

User produces a spoken utterance in a regional dialect toward terminal.

User provides, as input, an analog acoustic signal that encodes both linguistic content (for example, a request or complaint) and emotional cues (for example, anxiety or irritation).

User, for example, says “Being me some tea” to request tea or “I've been telling you this for a while now, but the TV isn't working!” to complain that a television does not turn on.

User outputs a continuous sound wave in air that is received by the microphone array of terminal.

### Step 2:

Terminal captures and digitizes the user's speech using a microphone array.

Terminal receives, as input, the analog acoustic signal from multiple microphone elements of the microphone array.

Terminal applies analog-to-digital conversion at a preset sampling rate (for example, 16 kHz) and bit depth (for example, 16 bits) and writes multi-channel pulse-code modulated frames into memory buffers.

Terminal thereby outputs multi-channel raw PCM audio data representing the user's utterance.

### Step 3:

Terminal performs local audio preprocessing including echo cancellation, noise suppression, beamforming, and volume normalization.

Terminal receives, as input, the multi-channel raw PCM audio data and, optionally, a reference audio signal being sent to its speaker.

Terminal executes an audio processing library to perform an adaptive filter-based echo cancellation that subtracts estimated echo components, applies a noise suppression algorithm (for example, spectral subtraction) to reduce background noise, performs beamforming (for example, delay-and-sum) to emphasize sound from the direction of the user, and normalizes the overall amplitude so that the RMS level falls within a predefined range.

Terminal outputs a single-channel or reduced-channel preprocessed PCM audio signal in which user speech is emphasized and noise components are attenuated.

### Step 4:

Terminal detects voice activity and segments the preprocessed audio into utterance units.

Terminal receives, as input, the preprocessed PCM audio signal.

Terminal applies a voice activity detection algorithm based on frame-level energy and spectral characteristics, or a small neural classifier, to label each frame as speech or non-speech, and groups consecutive speech frames into utterance segments.

Terminal attaches metadata such as a user identifier, a terminal identifier, and start and end timestamps to each utterance segment and outputs a set of utterance segments with associated metadata.

### Step 5:

Terminal compresses each utterance segment and transmits it securely to server.

Terminal receives, as input, each utterance segment with metadata.

Terminal encodes the audio using a perceptual audio codec (for example, a variable bit rate codec) to generate a compressed byte stream, then packages the compressed data together with metadata into a transmission message.

Terminal uses an encrypted communication protocol to send the message to server and outputs the transmitted compressed audio message on the network interface.

### Step 6:

Server receives and decodes the compressed audio message from terminal.

Server receives, as input, the compressed audio message containing compressed audio data and metadata.

Server parses the message to extract metadata fields and compressed audio payload, decodes the audio payload using a codec library to reconstruct a single-channel PCM waveform, and stores metadata and waveform in memory or a processing queue.

Server outputs a decoded PCM audio segment along with associated metadata (user identifier, terminal identifier, timestamps) ready for further processing.

### Step 7:

Server performs acoustic preprocessing and feature extraction for speech recognition.

Server receives, as input, the decoded PCM audio segment.

Server applies optional peak normalization and mild denoising using a signal processing library, then computes acoustic feature information such as log-Mel filterbank features or MFCCs by applying short-time Fourier transforms and Mel filterbanks over sliding windows.

Server outputs a two-dimensional feature tensor (time frames by frequency bins) that serves as input to a speech recognition model.

### Step 8:

Server executes a speech recognition model to generate dialect-containing character information.

Server receives, as input, the acoustic feature tensor.

Server feeds the tensor into a neural speech recognition model (for example, a Transformer- or Conformer-based model) running on a GPU, computes posterior probabilities over tokens for each time step, and applies a decoding algorithm such as beam search to determine the most probable sequence of tokens.

Server converts the token sequence into a Unicode string that includes dialect-specific expressions and outputs dialect-containing character information representing the recognized utterance.

### Step 9:

Server constructs a first prompt sentence for dialect-to-standard conversion.

Server receives, as input, the dialect-containing character information.

Server concatenates a fixed instruction sentence with the dialect text using string operations, creating a structured prompt sentence for a generative AI model.

Server, for example, generates the following prompt sentence as output:
“Please convert the following dialect sentence into polite standard Japanese without changing its meaning.
Dialect: ‘Bring me some tea’
Standard Japanese:”

### Step 10:

Server runs a generative AI model to convert dialect-containing character information into standard-language text data.

Server receives, as input, the first prompt sentence.

Server tokenizes the prompt using the tokenizer of the generative AI model, feeds the token sequence into a Transformer-based language model on a GPU, and performs autoregressive decoding under controlled parameters (for example, maximum length and low temperature) to generate continuation tokens corresponding to the requested standard-language content.

Server decodes the generated tokens back into a text string, trims any prompt echo, and outputs standard-language text data such as “Please bring me some tea.”

### Step 11:

Server extracts acoustic feature information for emotion recognition from the PCM audio.

Server receives, as input, the decoded PCM audio segment.

Server uses an audio analysis library to compute additional features such as fundamental frequency contours, frame-wise energy, spectral centroid, MFCCs, and temporal statistics including speaking rate and silence durations.

Server aggregates these measurements into a sequence of feature vectors and outputs an acoustic feature sequence tailored for emotion recognition.

### Step 12:

Server estimates a first emotional state from acoustic features using a first emotion recognition model.

Server receives, as input, the acoustic feature sequence.

Server feeds the sequence into a neural emotion classifier (for example, a bi-directional recurrent network or Transformer-based classifier) that has been trained with labeled emotion data, computes logits for each emotion category, applies softmax to obtain probabilities, and optionally predicts continuous intensity scores.

Server outputs a first emotion estimate that includes an emotion category distribution and one or more intensity values, such as neutral with intensity 0.6 and loneliness with intensity 0.3.

### Step 13:

Server estimates a second emotional state from text using a second emotion recognition model or a generative AI model.

Server receives, as input, at least one of the dialect-containing character information and the standard-language text data.

Server either tokenizes the text and feeds it into a text classifier to obtain emotion probabilities and intensities, or constructs a second prompt sentence for the generative AI model, for example:
“Please estimate the speaker's emotional state for the following utterance.
Emotion categories: joy, anger, anxiety, sadness, or neutral. Also output the intensity (0-1).
Utterance: ‘Bring me some tea’
Output format:
Emotion category:
Intensity:”

Server processes the model output, parses the emotion category and intensity fields, and outputs a second emotion estimate based on textual information.

### Step 14:

Server integrates the first and second emotion estimates to compute integrated emotional information.

Server receives, as input, the first emotion estimate and the second emotion estimate.

Server aligns categories from both modalities into a common vector space, assigns modality weights, and performs a weighted sum or passes concatenated score vectors to a meta-classifier to produce a combined emotion vector.

Server optionally computes an urgency index by analyzing temporal evolution of recent emotion vectors, then outputs integrated emotional information containing at least an emotion category, one or more intensity values, and an urgency index.

### Step 15:

Server constructs a third prompt sentence for response generation based on standard-language text data and integrated emotional information.

Server receives, as input, the standard-language text data, the original dialect-containing character information, and the integrated emotional information.

Server selects a response policy (for example, reassure, apologize, or instruct) according to emotion category and urgency index, and fills a response template with the user's utterance, standard-language interpretation, estimated emotional state, and response policy.

Server, for example, outputs a third prompt sentence such as:
“You are a conversational agent for a caregiving robot.

Under the following conditions, generate one polite and reassuring response to an elderly user.
User utterance (dialect): ‘Bring me some tea’
Content in standard Japanese: ‘Please bring me some tea’
Estimated emotional state: neutral (intensity 0.6), loneliness (intensity 0.3)
Response policy: accept the request and provide reassurance.
Output:”

### Step 16:

Server runs the generative AI model with the third prompt sentence to generate response character information.

Server receives, as input, the third prompt sentence.

Server tokenizes the prompt, passes token IDs into the generative AI model, and performs autoregressive decoding constrained by configured parameters to generate a natural-language response tailored to the specified policy and emotional state.

Server decodes the output tokens into text, trims extraneous content, and outputs response character information such as “Yes, I'll bring you some tea. I'll be there in a moment, so please wait just a moment.”

### Step 17:

Server generates control command information for a caregiving support apparatus based on response character information and integrated emotional information.

Server receives, as input, the response character information, integrated emotional information, and metadata including user and terminal identifiers.

Server queries a map or state database for positions of the caregiving support apparatus and locations such as a kitchen or user's room, and runs a path-planning algorithm to compute a travel route and travel speed that satisfy safety and comfort constraints.

Server combines destination position, waypoints, speed parameters, desired operation type (for example, bring tea), and content for audio and display outputs into a structured control command and outputs control command information addressed to terminal and the caregiving support apparatus.

### Step 18:

Terminal receives the control command information and executes speech synthesis and device control.

Terminal receives, as input, the control command information and the response character information from server.

Terminal parses the control command structure, extracts motion and task parameters, and passes the response text to a text-to-speech engine, which generates waveform data according to local voice settings.

Terminal sends synthesized audio samples to its loudspeaker for playback, and simultaneously uses robotic control middleware to convert route and speed parameters into low-level motor commands to move the caregiving support apparatus, while updating its display with the specified display output content.

Terminal outputs audible speech, visual feedback, and physical movement that together realize the requested caregiving action in accordance with the user's emotion and intent.

### Step 19:

Server logs interaction data and updates model parameters through a machine learning process.

Server receives, as input, logs of speech information, dialect-containing character information, standard-language text data, integrated emotional information, response character information, and optional execution outcomes from previous steps.

Server stores this data in a training database and periodically samples batches of stored data to perform gradient-based training or fine-tuning of the speech recognition model, the generative AI model, and the emotion recognition models, minimizing appropriate loss functions using optimization algorithms.

Server updates model weight parameters and outputs revised model states and configuration data, thereby improving recognition accuracy, emotional inference robustness, and response quality for future interactions.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

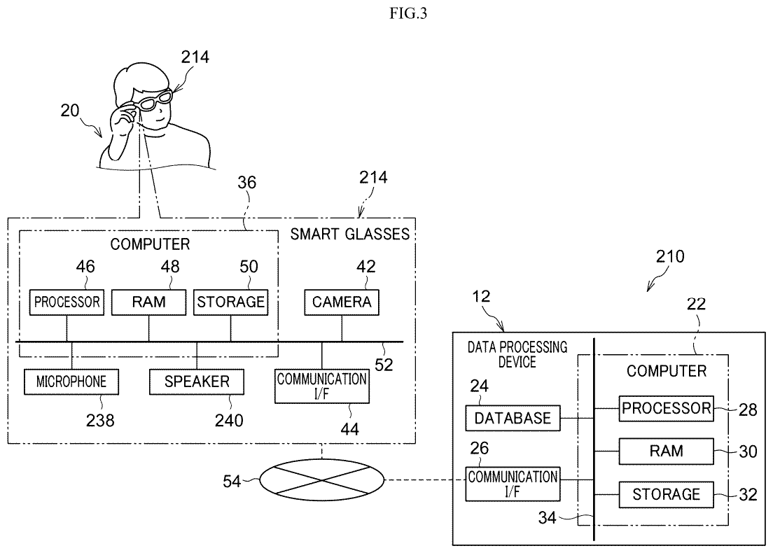

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

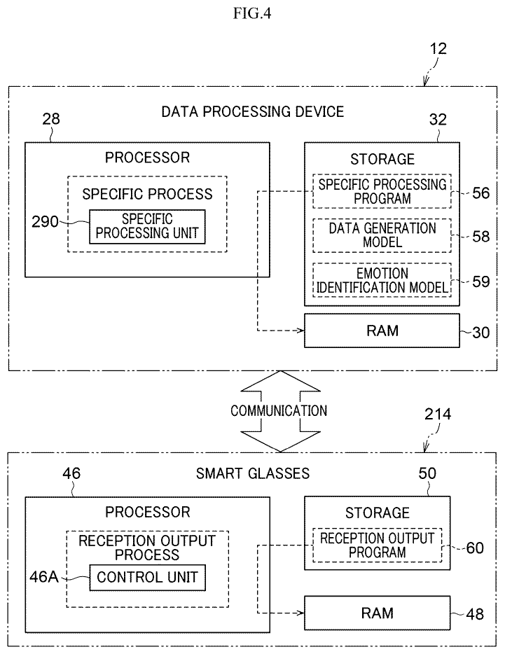

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples.

Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

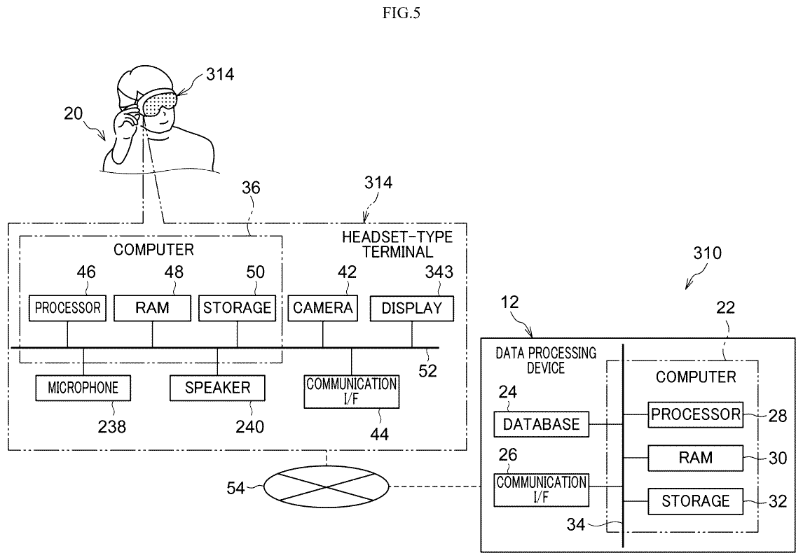

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

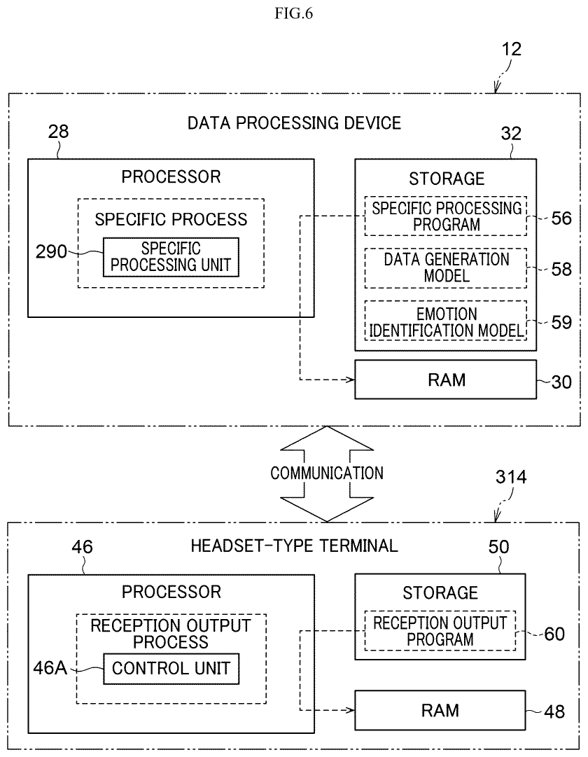

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network.

The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

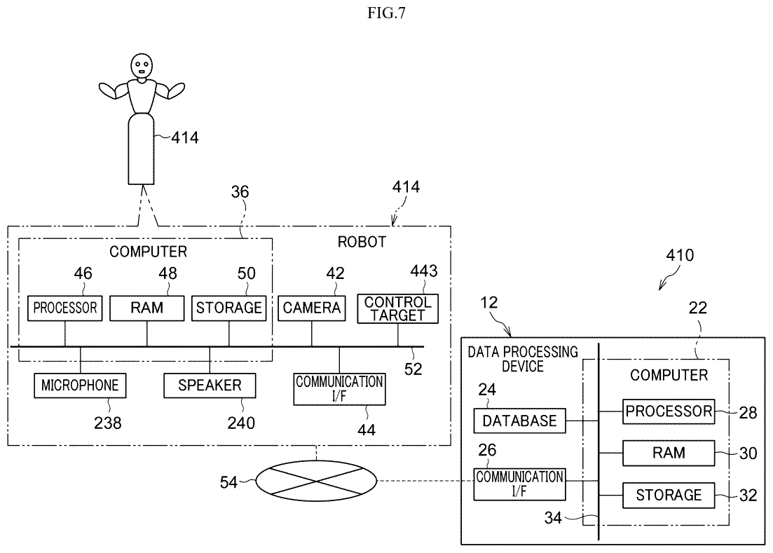

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

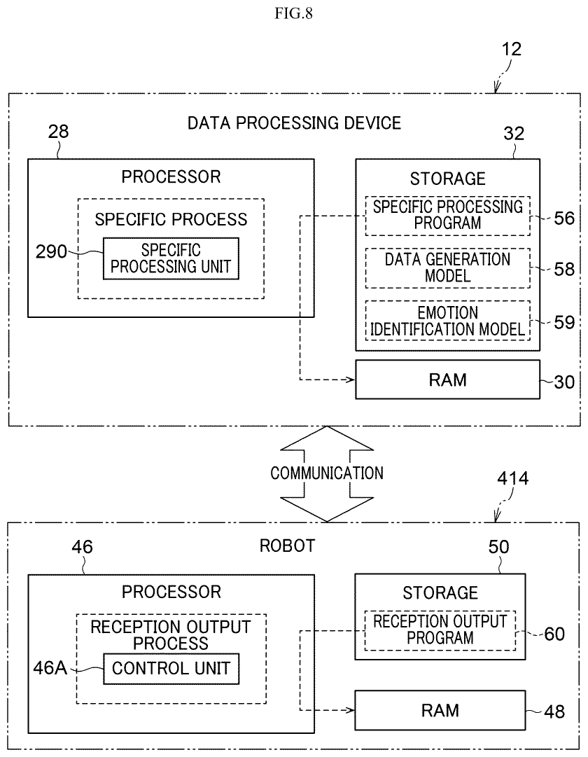

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

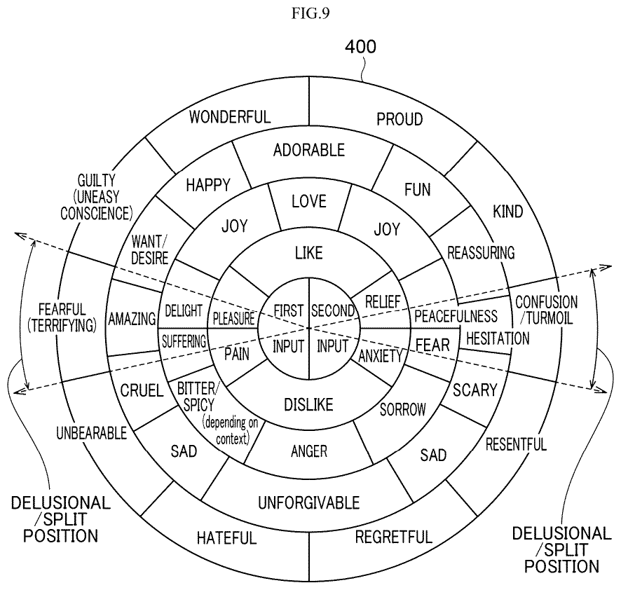

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

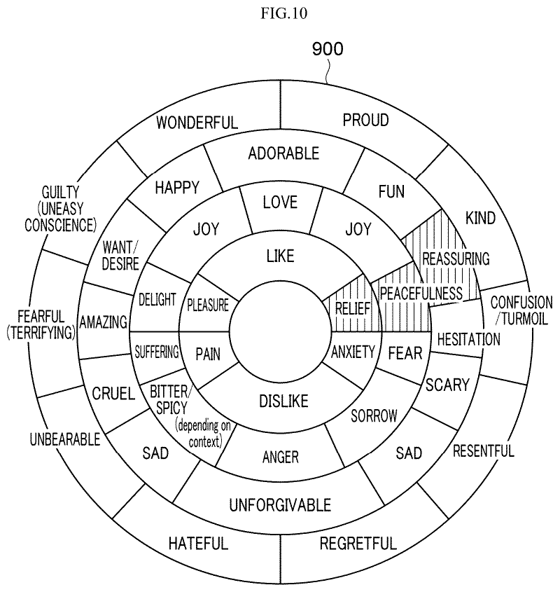

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to acquire speech information including a dialect uttered by a user via an information processing terminal operated by the user, and to receive, via a communication network, the speech information together with a prompt sentence presented to the user on the information processing terminal,
   wherein the processor is configured to store the received speech information in a storage medium and to register attribute information related to the speech information, including at least a dialect label, a scenario label, and an identification of the prompt sentence, in a management storage,
   wherein the processor is configured to perform signal processing on the received speech information and to execute preprocessing including at least noise reduction, removal of silent segments, and normalization of sound level,
   wherein the processor is configured to input the preprocessed speech information to a speech recognition process and to output character string information including dialect expressions by executing the speech recognition process,
   wherein the processor is configured to perform language processing on the character string information, to extract dialect vocabulary, to generate dictionary information indicating correspondence between the dialect vocabulary and standard language vocabulary, and to update and manage the dictionary information in a storage,
   wherein the processor is configured to calculate acoustic features and prosodic features from at least one of the speech information and the character string information, and to store the acoustic features and the prosodic features in a feature storage in association with the dictionary information,
   wherein the processor is configured to generate training data including the dictionary information, the acoustic features, the prosodic features, and the prompt sentence, and to input the training data to a generative AI model so as to train the generative AI model and construct a model that performs conversion between the dialect expressions and standard language expressions and performs post-processing of speech recognition considering the dialect, wherein the processor is configured to input evaluation data to the generative AI model, to compare output results from the generative AI model with reference data, to calculate evaluation indices, to analyze causes of misrecognition or mis-conversion, and, based on an analysis result, to adjust learning conditions or configuration parameters of the generative AI model and execute relearning,
   wherein the processor is configured to create, for each of a plurality of regional dialects, training data including speech information and character string information, to selectively construct either a single generative AI model common to the plurality of regional dialects or separate generative AI models for respective dialects, and to switch the generative AI model used for processing in accordance with a dialect type, and
   wherein the processor is configured to, during user operation, input dialect speech information received from the information processing terminal to the speech recognition process and the generative AI model, to generate instruction information normalized into standard language, and to transmit the instruction information to the information processing terminal so that an operation request for an information processing apparatus is output based on the instruction information.

### (Supplementary 2)

The system according to supplementary 1,
wherein the processor is configured to cause the information processing terminal to sequentially present, via a display unit of the information processing terminal, the prompt sentence corresponding to a scenario to the user, to cause the information processing terminal to acquire the speech information corresponding to daily conversation or a specific situation when the user utters in the dialect according to the prompt sentence, and to cause the information processing terminal to transmit, in a digital format, the acquired speech information and the prompt sentence in association with each other to the processor, and wherein the processor is configured to use the prompt sentence as a prompt sentence in the training data and to input the prompt sentence to the generative AI model so that the generative AI model learns correspondence among the prompt sentence, the dialect expressions, and the standard language expressions.

### (Supplementary 3)

The system according to supplementary 1,
wherein the processor is configured to input a standard language expression and the prompt sentence to the generative AI model as input information, to cause the generative AI model to generate a corresponding dialect expression as output information, to perform data augmentation processing by using a pair of the generated dialect expression and the standard language expression as additional training data, and to expand dialect handling capability of the generative AI model with respect to dialects for which speech information is not collected or for which only a small amount of speech information is collected.

### Application Example 1

### (Supplementary 1)

A system comprising a processor,
wherein the processor is configured to
acquire, by a voice data acquisition unit, uttered voice of a user,
preprocess, by a data preprocessing unit, the acquired voice data, train, by a model training unit, a generative AI model on the basis of the voice data and character information,
evaluate, by a test evaluation unit, performance of a voice recognition process using the generative AI model,
expand, by a dialect adaptation expansion unit, support from a particular dialect to other dialects,
control a terminal process by causing a terminal device to acquire an utterance of the user through an audio input device mounted on the terminal device, to perform noise suppression processing and directivity control processing on the acquired utterance, and to transmit the processed voice data to a server device via a communication network,
control server-side preprocessing by causing the server device to execute frequency component processing, reverberation suppression processing, volume normalization processing, and time information adding processing on the voice data received from the terminal device using a signal processing library,
execute, by the server device, a voice recognition model to generate a character string including a dialect, generate a prompt sentence to be input to the generative AI model, input a combination of the character string including the dialect and the prompt sentence to the generative AI model, and convert the character string including the dialect into a standard language character string,
extract, by a semantic analysis unit, an intention and a target of the user from the standard language character string and convert the intention and the target into structured control instruction information for device control,
generate, by a device control unit, a control message for an assistance device or an information processing device on the basis of the structured control instruction information and transmit the control message via a control network,
store, by a learning data management unit, pairs of the prompt sentence and a response sentence for causing the generative AI model to perform dialect generation or dialect-standard language conversion as learning data, and use the learning data for retraining of the generative AI model,
and record, by a feedback learning unit, a voice recognition result, a conversion result by the generative AI model, and a device control result in association with each other during actual operation, extract misrecognition cases, and register the misrecognition cases as retraining data for the voice recognition model and the generative AI model.

### (Supplementary 2)

The system according to supplementary 1,
wherein the processor is configured to
cause the generative AI model to generate the standard language character string by, for each dialect relating to a specific region, generating the prompt sentence indicating a correspondence between the character string including the dialect and a standard language character string, inputting the prompt sentence and the character string including the dialect to the generative AI model to output the standard language character string, and, for a specific standard language character string, generating the prompt sentence instructing expression of the specific standard language character string in a specific dialect, and registering a dialect expression obtained as a response of the generative AI model as learning data.

### (Supplementary 3)

The system according to supplementary 1,
wherein the processor is configured to
cause the dialect adaptation expansion unit, for each of a plurality of regional dialects, to repeatedly execute, as a common processing flow, processing of the voice data acquisition unit, the data preprocessing unit, the model training unit, the test evaluation unit, and a conversion unit using the generative AI model, compare and evaluate combinations of a voice recognition model and the generative AI model corresponding to each dialect, select an optimal model configuration, and expand support to an additional dialect stepwise by changing a format of the prompt sentence and generation processing conditions according to the selected model configuration.

### Example 2

### (Supplementary 1)

A system comprising a processor,
wherein the processor is configured to
acquire, by an audio data acquisition unit, audio data representing speech of a user, perform, by a signal processing unit, noise reduction, reverberation suppression, volume normalization, and frequency characteristic correction on the acquired audio data to generate a processed audio signal or acoustic feature values suitable for speech recognition and emotion estimation,
perform, by a language processing unit, speech recognition on the processed audio signal or the acoustic feature values to convert utterance content including dialect expressions into a first text sequence, convert dialect expressions included in the first text sequence into a second text sequence in a standard language, and generate dialect information including dialect type information and information on the dialect expressions,
estimate, by an emotion estimation unit, an emotional state of the user by classification or regression based on the acoustic feature values and the dialect information,
generate, by a prompt generation unit, a prompt sentence for a generative AI model based on at least the first text sequence, the second text sequence, the estimated emotional state, and dialogue scenario information, the prompt sentence defining, in natural language, conditions under which the generative AI model is to generate a response sentence,
generate, by a response generation unit, a response sentence in accordance with a dialect and response style specified in the prompt sentence by causing the generative AI model to operate using the prompt sentence as input,
verify, by a response verification unit, the response sentence generated by the response generation unit, by determining whether the response sentence includes an inappropriate expression or a semantic inconsistency, and selecting the response sentence or causing the generative AI model to regenerate the response sentence based on a result of the determination,
control, by an output control unit, transmission of the selected response sentence to a terminal device and presentation conditions of the selected response sentence on a display device and a speech synthesis device of the terminal device,
store, by a learning data management unit, the audio data, the first text sequence, the second text sequence, the emotional state, the prompt sentence, and the response sentence in association with one another as training data for a speech recognition model and an emotion estimation model, and
update, by a model learning unit, parameters of the speech recognition model and the emotion estimation model using the stored training data and auxiliary data generated by the generative AI model.

### (Supplementary 2)

The system according to supplementary 1,
wherein the processor is configured to
cause the audio data acquisition unit to execute a client application on a portable information processing device or a stationary information processing device, acquire a digital audio signal by sampling an analog audio signal from a microphone of the information processing device in response to an operation input of the user, buffer the digital audio signal at a predetermined sampling frequency and quantization accuracy, perform compression encoding on the buffered digital audio signal, generate metadata including user identification information, dialect identification information, and scenario identification information, and transmit the compressed digital audio signal and the metadata to a server via an encrypted communication protocol; and
cause the output control unit to adjust, based on the response sentence and speech synthesis parameters received from the server, at least one of font size, display contrast, speaking rate, and pitch of synthesized speech on the terminal device for presentation to an elderly user.

### (Supplementary 3)

The system according to supplementary 1,
wherein the processor is configured to
cause the prompt generation unit to select a prompt sentence template that specifies, in natural language, at least a role of the generative AI model, an output language type, a number of output sentences, a writing style, an allowable length, and an emotional target, based on intent information extracted from the second text sequence in the standard language, the emotional state, the dialect type, and dialogue history information, and to generate the prompt sentence by embedding the first text sequence and the second text sequence into the selected template so as to explicitly define generation conditions of the response sentence in the dialect; and
cause the model learning unit to generate pseudo data including dialect expressions and emotional expressions by using the prompt sentence and an output of the generative AI model, and to perform additional training of the speech recognition model and the emotion estimation model using the pseudo data.

### Application Example 2

### (Supplementary 1)

A system comprising a processor,
wherein the processor is configured to
acquire speech information from an information processing terminal that collects utterances of a user,
perform preprocessing on the acquired speech information by executing noise suppression, reverberation suppression, echo cancellation, volume normalization, and spatial directivity control to generate preprocessed speech information,
extract acoustic feature information from the preprocessed speech information and generate dialect-containing character information by inputting the acoustic feature information to a speech recognition model,
construct a prompt sentence for a generative AI model by concatenating a character string including the dialect-containing character information and an instruction sentence, and cause the generative AI model to autoregressively output standard-language text data using the prompt sentence as input,
estimate a first emotional state of the user by inputting the acoustic feature information extracted from the speech information to a first emotion recognition model,
estimate a second emotional state of the user by inputting at least one of the dialect-containing character information and the standard-language text data to a second emotion recognition model or to the generative AI model,
integrate an estimation result of the first emotion recognition model and an estimation result of the second emotion recognition model or the generative AI model to calculate integrated emotional information including at least an emotion category, an emotion intensity, and an urgency index,
generate, based on the standard-language text data and the integrated emotional information, a prompt sentence including conditions describing a response policy, a speaker attribute, and an output style, and cause the generative AI model to generate response character information to the user using the prompt sentence as input,
generate, based on the response character information and the integrated emotional information, control command information including at least a destination position, a travel route, a travel speed, an operation type, audio output content, and display output content, and transmit the control command information to the information processing terminal or to a caregiving support apparatus, and
store the speech information, the dialect-containing character information, the standard-language text data, the integrated emotional information, and the response character information as learning information, and update parameters of at least one of the speech recognition model, the generative AI model, and an emotion recognition model by executing a machine learning process using the learning information.

### (Supplementary 2)

The system according to supplementary 1,
wherein the processor is configured to
control the information processing terminal to acquire an acoustic signal around the user by using an acoustic input device including a plurality of elements, perform, by executing an acoustic processing program, voice activity detection, noise suppression, beamforming, and volume normalization on the acoustic signal, generate transmission speech information to which additional information including at least user identification information, terminal identification information, and time information is added for each detected voice section, transmit the transmission speech information to the processor by using an encrypted communication protocol, convert the response character information received from the processor into synthetic speech by executing a speech synthesis process and output the synthetic speech from an acoustic output device, and control a movement mechanism and a work mechanism of the caregiving support apparatus based on the control command information received from the processor.

### (Supplementary 3)

The system according to supplementary 1,
wherein the processor is configured to
input a prompt sentence for dialect-expression generation to the generative AI model, generate a plurality of candidate dialect expressions associated with the standard-language text data by using the generative AI model, incorporate the plurality of candidate dialect expressions into the learning information as additional learning information for the speech recognition model and the emotion recognition model, and execute retraining or fine-tuning of the models to improve performance in handling diversity of dialects.

What is claimed is:

1. A system comprising:
circuitry configured to:
receive, via a communication interface coupled to a packet-switched network, audio data representing speech in a regional language variant from one or more terminal devices;
perform preprocessing on the audio data including noise removal and convert the audio data into text data;
train a generative neural network model to learn variant-specific pronunciation and intonation based on the preprocessed audio data and corresponding text data;
evaluate an accuracy of speech recognition using the trained generative neural network model; and
expand support for speech recognition from a first regional language variant to additional regional language variants.

2. The system according to claim 1, wherein the audio data includes audio data of daily conversations and audio data recorded based on specific prompt scenarios transmitted to the one or more terminal devices, and wherein the circuitry stores the audio data in a storage device coupled to the packet-switched network together with attribute information including a variant label identifying the regional language variant, a scenario label, and a prompt identifier.

3. The system according to claim 2, wherein the preprocessing includes cleaning the audio data by applying a noise reduction filter, detecting and removing silent segments based on energy level thresholds, and normalizing a sound level of the audio data to a reference amplitude range.

4. The system according to claim 3, wherein the circuitry calculates acoustic features from the preprocessed audio data including mel-frequency cepstral coefficients and fundamental frequency contours, and calculates prosodic features including pitch patterns, speech rate, and accent positions, and stores the acoustic features and the prosodic features in a feature storage associated with the variant label.

5. The system according to claim 4, wherein the circuitry inputs the preprocessed audio data to the speech recognition model to obtain the text data, identifies variant-specific words and expressions in the text data by comparing against a standard language dictionary, and generates and updates dictionary information representing correspondence mappings between the variant-specific words and expressions and standard language equivalents.

6. The system according to claim 1, wherein the circuitry generates the training data by combining dictionary information mapping variant-specific vocabulary to standard language vocabulary, acoustic features extracted from the preprocessed audio data, prosodic features extracted from the preprocessed audio data, and prompt text used during audio collection.

7. The system according to claim 6, wherein the generative neural network model comprises a transformer-based architecture with an encoder configured to process the acoustic features and the prosodic features and a decoder configured to generate standard language text, and wherein the circuitry trains the generative neural network model using the training data to perform conversion between variant expressions and standard language expressions.

8. The system according to claim 7, wherein the circuitry further trains the generative neural network model to execute variant-aware post-processing on output of the speech recognition model by correcting variant-specific misrecognitions based on the dictionary information and the prosodic features.

9. The system according to claim 8, wherein the circuitry constructs a prompt data structure encoding the dictionary information and misrecognition patterns, transmits the prompt data structure to the generative neural network model, and receives from the generative neural network model suggested adjustments to at least one of learning rate, training data weighting, and feature selection parameters for subsequent retraining iterations.

10. The system according to claim 1, wherein the circuitry evaluates the accuracy by inputting evaluation audio data to the trained generative neural network model, comparing model output text against reference text data, and computing evaluation indices including a word recognition rate and a variant expression conversion accuracy rate.

11. The system according to claim 10, wherein the circuitry analyzes causes of misrecognition by categorizing errors into at least phonetic confusion errors, variant vocabulary errors, and prosodic interpretation errors, and generates an error analysis report associating each error category with a frequency count and example instances.

12. The system according to claim 11, wherein the circuitry automatically adjusts configuration parameters of the generative neural network model based on the error analysis report, including increasing training data weighting for error categories with frequency counts exceeding a threshold, and performs retraining of the generative neural network model using the adjusted parameters.

13. The system according to claim 1, wherein expanding support to additional regional language variants includes collecting audio data for a second regional language variant, generating variant-specific training data for the second regional language variant, and training either a shared generative neural network model that handles both the first and the second regional language variants or a separate generative neural network model dedicated to the second regional language variant.

14. The system according to claim 13, wherein the circuitry selects and switches between the shared or separate generative neural network models based on a variant type identifier received from the terminal device, and wherein the circuitry transfers learned parameters from the generative neural network model trained on the first regional language variant as initialization weights for training the generative neural network model for the second regional language variant.

15. The system according to claim 1, wherein the circuitry is further configured to, during runtime operation, receive speech audio data from a terminal device via the communication interface, input the speech audio data to the speech recognition model and the trained generative neural network model, generate instruction information normalized into standard language, and transmit the instruction information to the terminal device for controlling an information processing apparatus.

16. The system according to claim 15, wherein the circuitry generates a natural language response in the regional language variant by performing reverse conversion from standard language to variant expressions using the dictionary information, converts the natural language response into synthesized audio data using a speech synthesis model, and transmits the synthesized audio data to the terminal device.

17. The system according to claim 15, wherein the circuitry estimates an emotional state of a user based on at least one of prosodic features extracted from the speech audio data and interaction timing patterns received from the terminal device, and adjusts a response style of the generated instruction information based on the estimated emotional state including using simplified vocabulary when the estimated emotional state indicates confusion or frustration.

18. A system comprising:
a communication interface including a network interface controller coupled to a packet-switched network and configured to transmit and receive data packets;
a memory storing instructions, a speech recognition model, a generative neural network model comprising a transformer architecture with an encoder and a decoder, dictionary information mapping variant-specific vocabulary to standard language vocabulary, and acoustic and prosodic feature data; and
circuitry comprising one or more processors coupled to the memory and configured to execute the instructions to:
receive, via the communication interface, audio data representing speech in a regional language variant from one or more terminal devices;
perform signal processing on the audio data including noise reduction, silent segment removal, and sound level normalization to generate preprocessed audio data;
calculate acoustic features including mel-frequency cepstral coefficients and prosodic features including pitch patterns from the preprocessed audio data;
input the preprocessed audio data to the speech recognition model to obtain text data, extract variant-specific vocabulary, and update the dictionary information;
generate training data combining the dictionary information, the acoustic features, the prosodic features, and corresponding text data, and train the generative neural network model to perform conversion between variant expressions and standard language expressions;
evaluate the trained generative neural network model by computing word recognition rate and variant expression conversion accuracy against reference data; and
expand support to additional regional language variants by generating variant-specific training data and training additional generative neural network models.

19. The system according to claim 18, wherein the circuitry is further configured to analyze causes of misrecognition by categorizing errors into phonetic confusion errors, variant vocabulary errors, and prosodic interpretation errors, and to automatically adjust configuration parameters and retrain the generative neural network model based on the error categorization.

20. A method performed by circuitry of a server coupled to a packet-switched network via a communication interface, the method comprising:
receiving, via the communication interface, audio data representing speech in a regional language variant from one or more terminal devices;
performing preprocessing on the audio data including noise removal and converting the audio data into text data;
training a generative neural network model to learn variant-specific pronunciation and intonation based on the preprocessed audio data and corresponding text data;
evaluating an accuracy of speech recognition using the trained generative neural network model; and
expanding support for speech recognition from a first regional language variant to additional regional language variants.
